(19) United States
(12) Patent Application Publication
(10) Pub. No.: US 2007/0240190 A1
(43) Pub. Date: Oct. 11, 2007

(54) Method and system for enhancing the experience of a spectator attending a live sporting event

(76) Inventors: Marc Arseneau, Morin Heights (CA); Jean Arseneau, Boisbriand (CA); Alain Charette, St-Jerome (CA)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/607,852

(22) Filed: Dec. 4, 2006

Related U.S. Application Data
(60) Provisional application No. 60/789,911, filed on Apr. 7, 2006.

(51) Int. Cl. H04N 7/173

(52) U.S. Cl. 725/81; 725/120

(57) ABSTRACT

Method for enhancing the experience of a spectator attending a venue hosting a live sporting event. The method includes receiving locally of the venue a signal containing a plurality of video streams. At least one of the video streams is derived from a camera filming the live sporting event attended by the spectator and at least one of the video streams is derived from a camera filming a second live sporting event that is hosted at a second venue remote from the first venue. The method also includes using the signal to generate a wireless RF transmission locally of the first venue to allow the spectator to receive the wireless RF transmission with a handheld electronic device having a user interface, allowing the spectator to select a video stream among the plurality of video stream for display on the handheld electronic device.

### CROSS-REFERENCE TO RELATED APPLICATION

This application claims the benefit under 35 USC 119(e) of U.S. Provisional Patent Application No. 60/789,911 filed on Apr. 7, 2006 and hereby incorporated by reference herein.

### FIELD OF THE INVENTION

Broadly stated the invention relates to a system allowing wireless distribution of event-related video content. The invention also extends to individual components of the system and associated methods of operation and use.

### BACKGROUND OF THE INVENTION

The concept of delivering video and audio content to spectators attending a live sporting event is a known concept. The typical approach uses a local transmission station that will deliver video and audio content over the air to handheld electronic devices operated by individual spectators. A spectator can select the particular video/audio stream of interest on the handheld electronic device.

### SUMMARY OF THE INVENTION

As embodied and broadly described herein, the invention provides a method for enhancing the experience of a spectator attending a venue hosting a live sporting event, comprising:
a) providing a signal containing a plurality of video streams, wherein:
   i) at least one of the video streams is derived from a camera filming the live sporting event attended by the spectator, the live sporting event being a first live sporting event and the venue being a first venue;
   ii) at least one of the video streams being derived from a camera filming a second live sporting event that is hosted at a second venue remote from the first venue, wherein the first and the second live sporting events are concurrent at least in part;
b) using the signal to generate a wireless RF transmission locally of the first venue to allow the spectator to receive the wireless RF transmission with a handheld electronic device having a user interface, the user interface allowing the spectator to select a video stream among the plurality of video streams for display on the handheld electronic device.

As embodied and broadly described herein the invention also provides a method for enhancing the experience of a first spectator attending a first venue hosting a first live sporting event and of a second spectator attending a second venue hosting a second live sporting event, wherein the first and the second venues are remote from one another and the first and second live sporting events are concurrent at least in part, the method comprising:
a) providing a first signal containing a plurality of video streams, wherein:
   i) at least one of the video streams is derived from a camera filming the first live sporting event;
   ii) at least one of the video streams is derived from a camera filming the second live sporting event;
b) using the first signal to generate a first wireless RF transmission locally of the first venue to allow the first spectator to receive the first wireless RF transmission with a first handheld electronic device having a user interface, allowing the first spectator to select a video stream among the plurality of video streams for display on the first handheld electronic device;
c) providing a second signal containing a plurality of video streams, wherein:
   i) at least one of the video streams is derived from the camera filming the first live sporting event;
   ii) at least one of the video streams is derived from the camera filming the second live sporting event;
d) using the second signal to generate a second wireless RF transmission locally of the second venue to allow the second spectator to receive the second wireless RF transmission with a second handheld electronic device having a user interface, the user interface of the second handheld electronic device allowing the second spectator to select a video stream among the plurality of video streams in the second wireless RF transmission for display on the second handheld electronic device.

As embodied and broadly described herein the invention provides a data structure embedded in a wireless RF transmission, the wireless RF transmission being intended for reception by a plurality of handheld electronic devices of spectators at a venue hosting a live sporting event, the data structure conveying:
a) at least one video stream derived from a camera filming the live sporting event, the live sporting event being a first live sporting event and the venue being a first venue;
b) at least one of the video streams derived from a camera filming a second live sporting event that is hosted at a second venue remote from the first venue, wherein the first and the second live sporting events are concurrent at least in part, wherein a spectator at the first venue can receive the wireless RF transmission with a respective handheld electronic device having a user interface, allowing the spectator to select a video stream among the plurality of video streams for display on the handheld electronic device;
c) authentication data to prevent an unauthorized handheld electronic device at the first venue from accessing one or more of the video streams in the wireless RF transmission.

As embodied and broadly described herein the invention also provides a data structure embedded in a wireless RF transmission, the wireless RF transmission being intended for reception by a plurality of handheld electronic devices of spectators at a venue hosting a live sporting event, the data structure conveying:
a) at least one video stream derived from a camera filming the live sporting event, the live sporting event being a first live sporting event and the venue being a first venue;
b) at least one of the video streams derived from a camera filming a second live sporting event that is hosted at a second venue remote from the first venue, wherein the first and the second live sporting events are concurrent at least in part, wherein a spectator at the first venue can receive the wireless RF transmission with a respective handheld electronic device having a user interface, allowing the spectator to select a video stream among the plurality of video streams for display on the handheld electronic device;
c) data for setting the user interface of the handheld electronic device of the spectator.

As embodied and broadly described herein the invention provides a method for video content production, including:
a) receiving at a production site a first signal conveying a video stream derived from a camera filming a live sporting event, the live sporting event being a first live sporting event and being hosted at a first venue;
b) receiving at the production site a second signal conveying a video stream derived from a camera filming a second live sporting event hosted at a second venue that is remote from the first venue;
c) transmitting to the first venue a first data flow conveying a video stream of the first live sporting event and a video stream of the second live sporting event;
d) transmitting to the second venue a second data flow conveying a video stream of the first live sporting event and a video stream of the second live sporting event.

As embodied and broadly described herein the invention provides a video content production studio, comprising a mixing unit that has:
a) an input for receiving a first signal conveying a video stream derived from a camera filming a live sporting event, the live sporting event being a first event and being hosted at a first venue and also for receiving a second signal conveying a video stream derived from a camera filming a second live sporting event hosted at a second venue that is remote from the first venue
b) a mixing unit for processing the first and the second signals and generating:
   i) a first data flow conveying a video stream of the first live sporting event and a video stream of the second live sporting event;
   ii) a second data flow conveying a video stream of the first live sporting event and a video stream of the second live sporting event;
c) an output for transmitting the first data flow to the first venue and the second data flow to the second venue.

As embodied and broadly described herein the invention also provides a method for graphically presenting to a spectator attending a first live sporting event a list of video streaming options from which the spectator can select a desired video stream for viewing on a screen of a handheld electronic device, wherein at least one of the video streaming options conveys video content derived from a camera filming a second live sporting event that is concurrent at least in part with the first live sporting event, the method comprising:
a) displaying on the screen of the handheld electronic device a series of graphical option items associated with respective ones of the video streams, the option items being individually selectable by the spectator to effect a choice of a video stream to view on the screen;
b) displaying on the screen identifying information in connection with each option item, the identifying information describing a characteristic of the live sporting event from which the video stream associated with the option item is derived.

As embodied and broadly described herein the invention also provides a handheld electronic device for use by a spectator at a venue hosting a live sporting event, wherein the venue is a first venue and the live sporting event is a first live sporting event, the handheld electronic device comprising:
a) a receiver for receiving a wireless RF transmission containing at least two video streams conveying live video sporting event content, one of the video streams being derived from a camera filming the first live sporting event and one of the video streams being derived from a camera filming a second live sporting event held at a second venue that is remote from the first venue;
b) a screen;
c) a user interface for selecting a video stream among the plurality of video streams to be viewed on the screen, the user interface capable of displaying on the screen a series of graphical option items associated with respective ones of the video streams, the option items being individually selectable by the spectator to effect a choice of a video stream to view on the screen.

### BRIEF DESCRIPTION OF THE DRAWINGS

A detailed description of examples of implementation of the present invention is provided hereinbelow with reference to the following drawings, in which:

FIG. 1 is a block diagram of a system according to a non-limiting example of implementation of the invention;

FIG. 2 is a block diagram of system components at a venue serviced by the system shown at FIG. 1;

FIG. 3 is a block diagram of a production studio used in the system shown at FIG. 1;

FIG. 4 is a more detailed block diagram of a content production station shown at FIG. 3;

FIG. 5 is a more detailed block diagram of a head-end station shown at FIG. 3;

FIG. 6 is a perspective view of a device used by an attendee at a venue serviced by the system according to the example of FIG. 1;

FIG. 7 is a functional block diagram of the device shown at FIG. 6;

FIG. 8 is a flow chart of process for authenticating the device shown at FIG. 6;

FIGS. 9 to 14 are examples of screen views of the handheld electronic device illustrating typical information that can be delivered to the spectator;

FIG. 15 is a high level block diagram of the handheld electronic device showing components to perform authentication function;

FIG. 16 is a block diagram of a processor that is external of the handheld electronic device to generate a user code; and

FIG. 17 is a block diagram of an authentication processor shown in FIG. 15.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

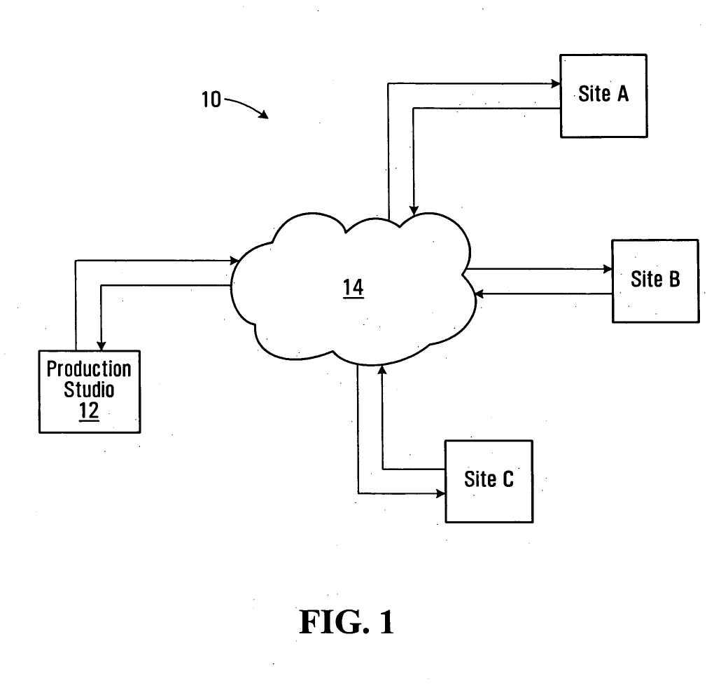

FIG. 1 illustrates an overall architecture of a system, in accordance with a non-limiting example of implementation of the present invention intended to enhance the experience of a spectator attending a live sporting event that takes place at a certain venue. A live sporting event is a gathering of a large number of people, several hundreds or more, attending a public sports performance. Examples of live sporting events include but are not limited to:
A motor sport event, such as a car race, or motorcycle race;
A golf tournament;
A football game;
A soccer game
A baseball game
A hockey game;
A tennis game;
A horse race;
A polo game;
A basketball game;
The Olympic games

The system 10 delivers to spectators attending a football live sporting event video, audio and data content. For clarity, the invention can be used in connection with a wide variety of live sporting events without departing from the spirit of the invention. Accordingly, while the examples of implementation provided in this specification are made in connection with a football game, this should not be considered as a limiting feature.

As shown in FIG. 1, the system 10 is implemented over a fairly wide geographical area and includes an infrastructure having components in multiple venues that can be at a significant distance from one another. In the example shown, the system 10 involves three venues, namely venue A, venue B and venue C. Each venue can be a stadium in which a football game can be played. Those stadiums would normally be located in different cities that can be many miles apart. The system 10 also includes a production studio 12 that is remote from venue A, venue B and venue C. In a specific and non-limiting example, the production studio 12 is located in yet another city and may even be located in a country that is different from the country in which sites A, B or C are located.

The production studio 12 and sites A, B and C are all linked via a data connection shown as a network 14. The network 14 allows data to be sent from any one of the sites A, B or C to the production studio 12 and also allows data to be sent from the production studio 12 to any one of the sites A, B or C. The type of network 14 used to perform the data transport function from the sites A, B and C to and from the production studio 12 is not critical as long as it can meet sufficient performance requirements. Networks based on optical fiber technology that provide a high bandwidth, low latency and high speed data transmission have been found satisfactory. Note that the network does not need to be strictly landline based buy may include wireless segments.

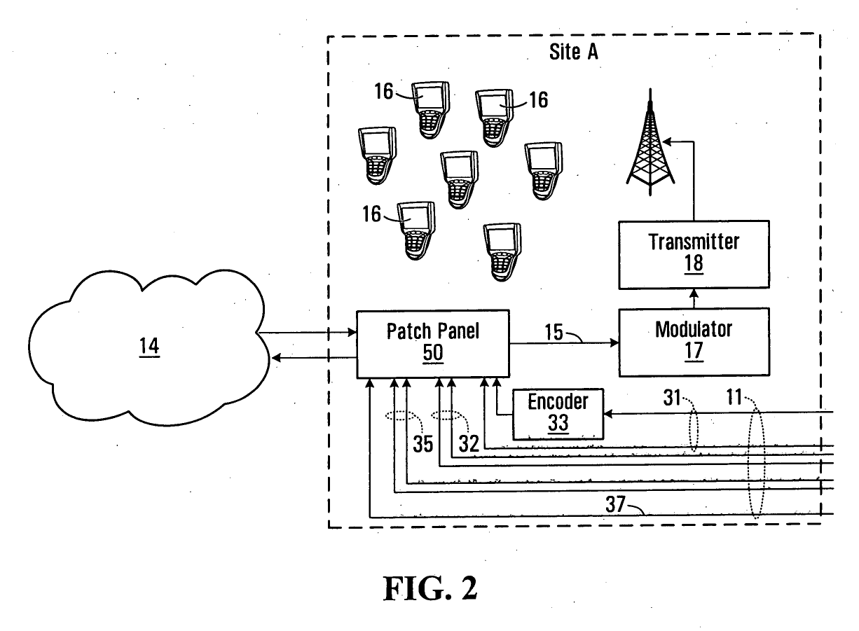

FIG. 2 illustrates in greater detail the components of the system infrastructure at venue A. The system 10 includes a series of inputs 11 that capture audio, video and data content associated with the local live sporting event, such as for example the football game held at venue A. The system 10 also includes an output 15 that returns to venue A a digital signal having a video/audio/data content that is then locally broadcast to individual portable devices 16, each device 16 being intended to be used by a single attendee or spectator watching the live sporting event. In a typical application, a significant number of devices 16 can be accommodated. For instance, in a football game that may attract several tens of thousands of attendees, the system infrastructure at a single venue should be designed to potentially support an equal number of portable devices 16.

The transmitter 18 communicates with the individual handheld electronic devices 16 in a wireless manner. In the example that is being shown in the drawings, the communication is a Radio Frequency (RF) communication. This RF transmission is unidirectional. In other words, the information stream is from the transmitter 18 to each electronic device 16. This is accomplished in the broadcast mode wherein each electronic device 16 receives the same information from the transmitter 18. In the unidirectional RF transmission, the handheld electronic devices 16 are unable to transmit information back to the transmitter 18 over the wireless RF communication link.

In a non-limiting example of implementation the wireless RF transmission is performed locally of the venue. “Locally of the venue” means that the antenna generating the wireless RF transmission originates either at the venue or outside the venue but generally close to the venue. The signal power level is also controlled such that handheld electronic receivers 16 can adequately receive the wireless RF transmission at the venue, but at significant distances from the venue the signal weakens and may no longer permit a quality reception. By “significant” distance is meant a distance in terms of kilometer range.

It should be understood that the handheld electronic devices 16 can be capable of unidirectional wireless communication, as described above, or alternatively, they can be capable of bi-directional wireless communication. In the case of unidirectional wireless communication, the handheld electronic devices 16 are only able to receive wireless information. In other words, they are not able to transmit information back to the transmitter 18, or to another receiver/transmitter, over a wireless communication link. It should be appreciated that although the handheld electronic devices 16 may only be capable of unidirectional wireless communication, they may be operative to transmit and receive information over a wireline link, such as via a USB connection port, for example.

In the case of bi-directional wireless communication, each handheld electronic device 16 is able to receive information over a wireless communication link, and is also able to transmit information over a wireless communication link. In this case the electronic device 16 is provided with an RF transceiver (not shown in the drawings) that can handle the receive and transmit functions. The transmitted information may be sent to an entity of the system 10 (not shown), or to an entity of an external network that is independent of the system 10. The handheld electronic devices 16 may be operable to transmit information over a wireless RF communication link, such as over a cellular link. In the case of a cellular link, the handheld electronic devices 16 would dial a phone number and then transmit information over the cellular phone link.

The bi-directional communication feature may be implemented to provide identical or similar bandwidths over the receive and transmit links. However, in most cases, this is not necessary since the amount of information that needs to be sent from the handheld electronic device 16 is generally different from the amount of information that it needs to receive. Typically, the handheld electronic device 16 needs to send far less information that it receives. The implementation using the cellular network is an example that would provide a sufficient bandwidth over the transmit link. By “cellular” network is meant a network that uses a series of cells having a limited geographical extent within which communication services are available. In one possible form of implementation, such cells can be arranged to provide a hand-off to moving handheld electronic devices 16, such that as a handheld electronic device 16 moving outside a cell and entering a new cell, the communication services are seamlessly transferred from one cell infrastructure to another cell infrastructure. The “cellular” network terminology encompasses both communication infrastructures using licensed bandwidth, such as typical cellular telephones based on Code Division Multiple Access (CDMA), Time Division Multiple Access (TDMA), Groupe Station Mobile (GSM), or other technologies, and communication infrastructures using unlicensed bandwidth, such as Wireless Fidelity (WiFi) that is used commonly to provide wireless access to computer networks. Another possible example of a “cellular” technology using unlicensed bandwidth is the so called “Bluetooth” protocol that provides very short range wireless communication capabilities.

The cellular network allows the handheld electronic device 16 to transmit information over a relatively limited bandwidth, however, in most cases the amount of information that needs to be sent is low such the available bandwidth should suffice. On the other hand, the receive link has a higher bandwidth in order to accommodate the multiple video streams and other data that is to be sent to the handheld electronic device 16. Also the cellular link allows the handheld electronic devices 16 to transmit information independently from one another.

The input 11 receives signals that convey video/audio/data content originating form various sources. In the example shown in FIG. 1, a number of content sources are shown, which for the purposes of the present application will be described in the context of a football game. There are multiple video feeds 31 that originate from cameras along the football field. The cameras capture images of the live football game and output the video information making up the respective video feeds 31. Note that one of the video feeds 31 leads to an encoder 33. This encoder 33 can be provided to encode the native video format in any suitable format that may be necessary to facilitate the transport of the video signal or its processing at the production studio 12. The encoder 33 is optional and can be omitted if the encoding of the video feed is not required or can be done elsewhere in the system 10.

Multiple audio feeds 32 are also provided, where each audio feed 32 is associated with a video feed 31. An audio feed 32 conveys audio information such as the noise picked up by a microphone at a location at which the associated camera is placed, or an audio commentary. Such an audio commentary can be the speech picked up by a microphone from a commentator or any individual that appears in one or more of the video feeds 31. Note that the audio feeds 32 are shown separate from the video feeds 31 for clarity only. In many practical applications the video feed 31 and the associated audio feed 32 will be carried over a common physical conductor.

Independent audio feeds 35 are also provided that convey independent audio content which is not associated with any particular video feed 31. For instance those independent audio feeds 35 may be radio conversations between members of a football team or a radio commentary by a reporter over a radio channel. Such audio conversations can be picked up by one or more radio receivers (not shown) each tuned to a particular frequency.

The audio and video content is typically supplied by the authority managing the live sporting event. For example, in the case of a football game, the video and audio data might by supplied by the National Football League. (NFL). In a further non-limiting example, the independent audio feeds that contain audio commentary may be supplied by the commentator's affiliated television network, such as TSN, for example.

The input 11 also receives a real time data content 37. The real time data content 37 conveys information relating to the action in the field. For example, the real time data content in the context of a football game can be:
the present score;
time remaining to play;
penalties
number of time outs left;
current down;
number of downs left;
yardage to go, among others.

The real time data content 37 is typically also supplied by the authority managing the live sporting event.

The video content, the audio content and the data content are physically input into a patch panel 50 that is the entry point in the network 14. The network 14 transports this video/audio/data content to the remote production studio 12 where it will be edited.

The infrastructure of the system 10 for sites B and C functions in the same way as described above. Specifically, each of the sites B and C produces audio/video/data content that is transported to the production studio 12 for editing. In a specific example of implementation each venue is hosting a football game between two teams and the games are concurrent at least in part. In the context of two sites, say sites A and B, games concurrent at least in part means that each venue is hosting a football game and both games overlap time wise. In other words, when one of the games begins, the other game starts concurrently or has already started. With games concurrent at least in part, game action occurs simultaneously at different sites. In a specific and non-limiting example of implementation, the games at the venues serviced by the system 10 (sites A, B and C) start simultaneously. The games are unlikely to end at the same time since the duration of an individual game can vary but for the most of the duration of the game, three different game actions occur simultaneously at different sites remote from one another. In this example the game that is held at each venue is the same type of game, namely a football game. The invention can also be used in applications where different types of games occur at the sites A, B and C and those games are concurrent at least in part. For example, venue A may be hosting a football game, while sites B and C are hosting baseball games. The game at venue A starts at 7:00 PM while the games at sites B and C start at 7:30 PM. Thus, from 7:30 PM three different game actions are in occurrence, there being one football game and two baseball games.

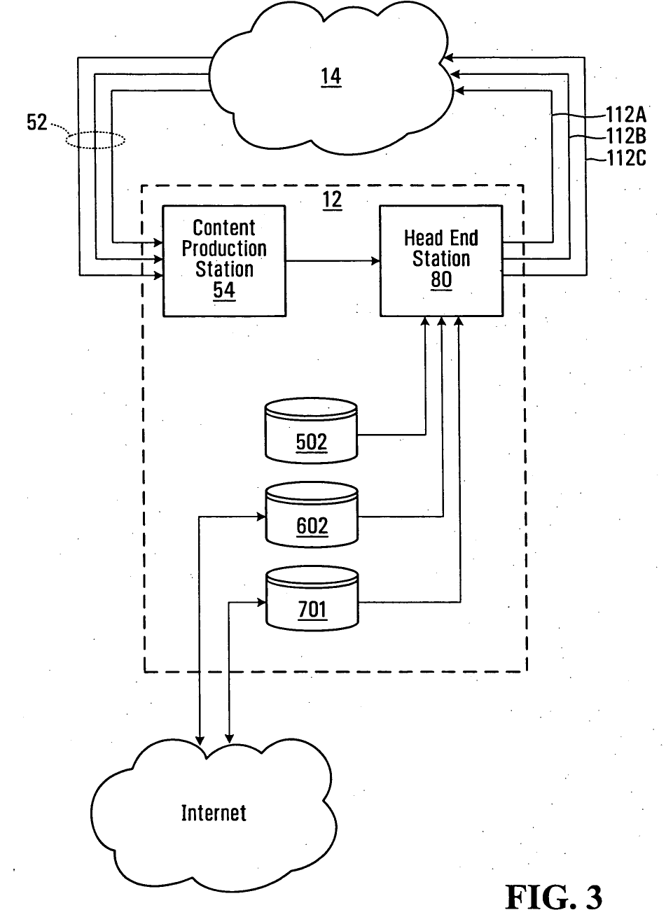

FIG. 3 is a more detailed block diagram of the production studio 12. The production studio 12 connects to the network 14 via an input 52 and receives via that input 52 the video/audio/data content originating from the sites A, B and C. For clarity the input 52 is depicted as three arrows, each symbolizing collectively the video/audio/data content originating at a different site. The video/audio/data content from each venue is received at a content production station 54. The content production station 54 is an optional component and it provides a facility where a technician can format or edit the raw content to make it more suitable for presentation to the audience. The content production station 54 includes a console that allows the technician to conduct the necessary content editing operations.

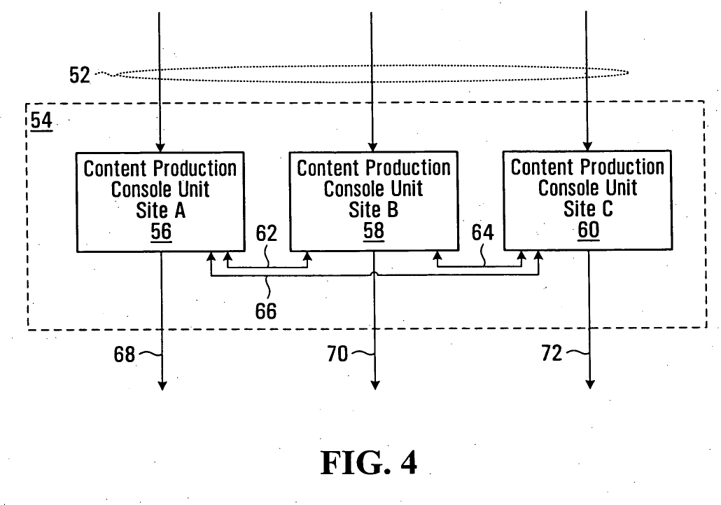

FIG. 4 is a more detailed block diagram of the content production station 54. The content production station 54 has several content production consoles each associated with a site. In the example shown, there are three content production console units 56, 58 and 60 associated with the sites A, B and C, respectively. Each content production console unit 56, 58 and 60 can edit the video/audio/data content originating at a given site. The editing operation includes selecting among the video/audio/data information that arrives at input 54, the one that will be eventually delivered to the spectators. For example, the video/audio/data content from a given venue may contain several video feeds. The technician at the content production console unit 56, 58, 60 can chose the video feed that will be delivered among the video feeds available. The same operation can be performed on audio and data content. Also, note that the content production station 54 can edit the video/audio/data content, if desired.

The content production console units 56, 58 and 60 can also mix the content. The mixing function is accomplished by linking the content production console units 56, 58 and 60 to one another via data interconnects 62, 64 and 66. The data interconnects 62, 64 and 66 allow content that originates from one venue A, B or C to be delivered to the content production console unit 56, 58, 60 associated with another site. The way in which the content mixing operation will be performed is under the direct control of the operator of the content production station 54.

Each content production console unit 56, 58, 60 has an output 68, 70 and 72 that releases an edited and mixed audio/video/data content. Examples of mixing operations include:

1. Venue A, Venue B and Venue C Host Football Type Games that are Concurrent at Least in Part.
The mixing operation includes directing at least one video feed 31 and an associated audio feed 32 originating at venue A into the content of each of the sites B and C. The same operation is performed with the content of sites B and C such that the content associated with each venue will also hold a video feed and an associated audio feed from each other site. For instance, assume that the video/audio/data content that is input into the content production console unit 56 includes a single video feed and a single associated audio feed associated with venue A. Similar operations are performed by the content production console units 58, 60 on the video/audio/data content from sites B and C, respectively. After the mixing operation, the video/audio/data content released by the content production console unit 56 at output 68 will contain three video feeds and three associated audio feeds, where each video feed and the associated audio feed originate from a different site. The same operation happens at the content production consoles 58, 60 that output at 70 and 72, respectively video feeds and associated audio feeds originating from different sites.
In a possible variant, In addition to mixing video and associated audio, independent audio content can also be mixed. The process is effected generally as described earlier. Independent audio content originating from anyone of the sites A, B or C is directed via anyone of the data interconnects 62, 64, 66 into the content output 68, 70, 72 of another venue A, B, C. In a specific example the independent audio content originating from each venue A, B, C is injected in the content output 68, 70, 72 associated with every other site. In this fashion, the video/audio/data content in every output 68, 70, 72 contains independent audio content from every venue A, B, C.
Yet, in another variant, in addition to mixing video and audio (associated and/or independent), data can also be mixed, generally in the manner as described earlier.
It will be appreciated that the number of video feeds, associated audio feeds, independent audio feeds and data elements that are being mixed can vary without departing from the spirit of the invention. Depending on the number of video feeds, associated audio feeds, independent audio feeds and data elements present in the video/audio/data content originating at a certain venue one, two or more of those components can be mixed with content from other sites.

2. Venue A and Venue B Host Football Type Games that are Concurrent at Least in Part and Venue C Hosts a Motor Sports Event.
In this form of implementation the mixing of video/audio/data content occurs between sites A and B. Venue C operates independently. In other words, the data interconnects 64 and 66 are not used. This example assumes that there is no interest for spectators at sites A and B to obtain content from venue C hosting a different event. In the case interest exists, the operation can be effected in the same way as example 1.

3. International Competitions such as the Olympic Games or the World Soccer Cup.
This form of implementation would be similar to 1 above. Consider for example the Olympic Games where several events may occur and those may be concurrent at least in part. The events are different from one another, for example one may be a swimming competition, one may be athletics competition and one is a boxing competition. All those events are held in different venues. The video feeds, associated audio feeds, independent audio feeds and the data elements are received from each venue and send to the content production station 54 where they are mixed as required. After the mixing operation, the video/audio/data content released by the content production console unit 56 is directed to the individual venues as discussed above.
An implementation during the World Soccer Cup would be essentially the same as the Olympic Games, the exception being that the same type of sport is being played, namely soccer games, at the various venues.

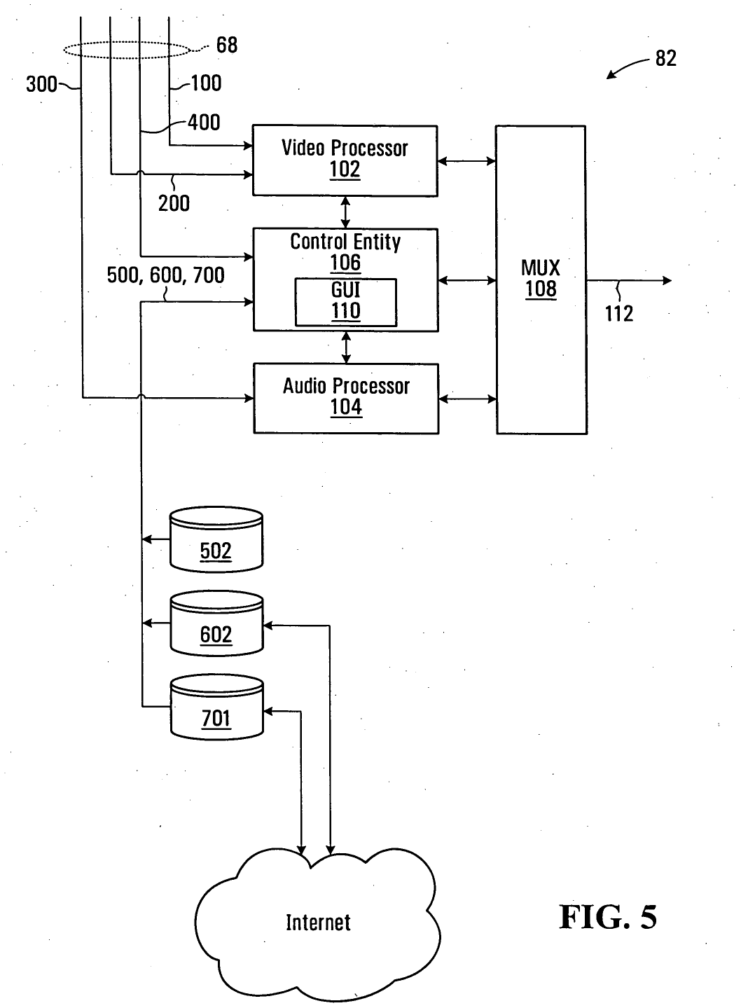

Referring back to FIGS. 3 and 4, the content at outputs 68, 70, 72 that is released from the content production station 54 is directed to a head end station 80. The head end station 80 is a modular entity having individual components associated with respective content production console units 56, 58 and 60. One of the components of the head end station 80 is shown in greater detail in FIG. 5. That component, referred to as “head end station unit” 82 is associated with the content production console unit 56 and it processes the video/audio/data content on output 68. The two other head end station units associated with the content production console units 58 and 60, respectively, are not shown in the drawings for clarity. Those head-end station units operate in the same way as head end station unit 82.

The head end station unit 82 receives seven different inputs. Those inputs are broadly described below:
1. The first input, designated by reference numeral 100 includes the multiple edited video feeds that are present in the output 68 from the content production console unit 56. The video feeds include one or more video feed originating from venue A and one or more video feeds originating from venue B and/or from venue C depending on the mixing operation performed by the content production station 54. In a specific example of implementation the video feeds 100 are transmitted according to a Serial Digital Interface (SDI) format.
2. The second input 200 includes the multiple edited audio feeds that are associated with respective video feeds in the input 100. Those audio feeds include one or more audio feeds originating from venue A and one ore more audio feeds originating from venue B and/or from venue C depending on the mixing operation performed by the content production station 54. The audio feeds in the input 200 can be transmitted in any suitable format.
3. The third input 300 includes the multiple independent audio feeds. Those audio feeds include one or more audio feeds originating from venue A and one or more audio feeds originating from venue B and/or from venue C depending on the mixing operation performed by the content production station 54. The audio feeds in the input 300 can be transmitted in any suitable format.
4. The fourth input 400 includes the real time data content that is transmitted digitally to the head end station unit 82. This content includes content originating from venue A and also content originating from venue B or from venue C depending on the mixing operation 30 performed by the content production station 54. For example, the real time data content in the context of a football game can be:
   the present score;
   time remaining to play;
   penalties
   number of time outs left;
   current down;
   number of downs left;
   yardage to go, among others.
In another example, the real-time data content can also convey physiological information associated with anyone of the participants. Again in the context of a football game, the physiological information can include the heart rate of a player or his body temperature, among others. The real time data content is usually available from the authority sanctioning the live sporting event. In the case of the physiological information, one possible implementation would require providing one or more of the participants with the necessary sensors that measure the heart rate, body temperature, etc and convey the collected information to the head end station unit 82. It is not deemed necessary to describe in detail how the physiological information is collected and delivered to the head end station unit 82, since this would be known to a person skilled in the art.
5. The fifth input 500 includes authentication data received from an authentication database 502. The authentication data 500 is digitally transmitted to the head end station unit 82. Note that for simplicity inputs 500, 600 and 700 are shown by a single arrow. In practice the data in those inputs can be conveyed over separate or common conductors.
6. The sixth input 600 includes ancillary content that is output from an ancillary information database 602. The ancillary content 600 can be in the form of video, audio or data, such as text for display to the spectator. Examples of ancillary content includes:
   a) Advertisement content. The advertisement content can be delivered in the form of video, audio or a combination of video and audio. Examples include short movies, still images, or portions of still images appearing as overlays on other video content appearing on the user's screen. The advertisement content can be delivered in a wide variety of ways. Examples include:
      i) A first possibility is to broadcast the advertisement content such that it is played at each handheld electronic device 16. In this fashion each spectator is exposed to the same content. Ads can be channeled to the handheld electronic devices 16 over individual video/audio streams such that the spectator can select when to view the ads or not view the ads. For example, the handheld electronic device 16 can be programmed in a way to allow the spectator to access a special add channel that continuously runs the ads content. Alternatively, ads can be inserted in the video/audio streams that convey the event-related content. For example during idle times, ads can be run. Such ads can be in the form of short movies that are played on the handheld electronic device 16 for a predetermined time period, such as 30 seconds. Another possibility is to present the ads as banners, logos or in a “ticker” type fashion that appears on certain areas of the handheld electronic device's screen.
      ii) A second possibility is to deliver the ad content according to spectator profiles. The ads are organized into blocks, where each block corresponds to a spectator profile. Spectator profiles can be defined in various ways, such as age groups, gender, level of revenue, area of interest or combinations of the above, among many others. For instance, with profiles that are distinguished from one another on the basis of gender, ads that are intended to attract the interest of males can be directed in one profile while ads that are more likely to be of interest to females can be placed in the other profile. In the case of profiles that are distinguished on the basis of revenue level, ads on products or services would be placed in profiles according to the cost of the product or service; more expensive products or services would be placed in profiles associated with higher revenue levels.
   b) Venue or event related contextual content. In the case of football games, the contextual content may include information about the sport such as, the history of the sport, the list of the teams involved in the championship, the information about each team, statistics about each team or about individual team members, instructions on where to find certain facilities at the venue such as washrooms, vending machines or stands, among many others.
   c) News. The news content may include “breaking” news bulletins, weather information, and economic information such as stock exchange averages or indices, among others.
   d) Environmental conditions. In the case of certain live sporting events, environmental conditions can greatly affect the way the game is played. As such, information relating to environmental conditions such as current temperature, wind speed and direction, humidity, weather forecast, etc. . . . might be of interest to a spectator.
   e) Shopping Information. A shopping service may be provided to a spectator in order to enable the spectator to purchase products and paraphernalia related to the live sporting event, such as T-shirts, caps, related sporting equipment and autographed items from the players or participants. The shopping information may be displayed in the form of an electronic catalogue of purchasable items that lists the products and paraphernalia that are for sale. The shopping catalogue may also include products from the sponsors of the sporting event.
In a non-limiting example of implementation, the advertisement information described above in paragraph a) may be tied into the shopping service. For example, during the sporting event, the advertisement information may indicate to a spectator that products from the event's sponsors are available for purchase in the on-line shopping catalogue. In addition, when an exciting event occurs in the live sporting event, such as the winner of the football game is determined, the advertisement information can indicate to a spectator that T-shirts and other items associated with the winner of the event can be bought via the on-line shopping catalogue.
In order to purchase products from the on-line shopping catalogue, a spectator would add selected items to a virtual “shopping cart” and then “checkout”.
In the case where the handheld electronic device 16 is only capable of unidirectional wireless communication, the spectator would then have to physically connect the handheld electronic device 16 (via a USB port, for example) to a purchasing terminal located at the sporting event, or to their PC when they arrive home. The purchasing information would then be downloaded from the handheld electronic device 16 to the terminal or PC, which can then transmit the information to the appropriate entity.
Alternatively, in the case where the handheld electronic device 16 is capable of bi-directional wireless communication, as described above, the purchasing information can be sent immediately over a wirelessly communication link, to an appropriate receiver/transmitter. The appropriate receiver/transmitter may be part of the system 10, or may be part of an external network.
The ancillary content 600 can be obtained from a wide variety of sources. The advertisement, shopping, venue or event related information can be recorded on any suitable medium and injected in the video/audio content at the head end station 80. Specifically, the advertisement, shopping, venue or event related information could be digitally stored on a database 602. The output of the database 602 leads to the head end station 80 such that the video/audio content in the database 602 can be injected in the video/audio content that is being broadcast to the handheld electronic devices 16. The Internet is another source of ancillary content. Specifically, the news service can be delivered from the internet and injected in the video/audio content that is being broadcast to the handheld electronic devices 16.
7. Finally, the seventh input 700 includes service data. The service data resides in a database 701. This database can also connect to the Internet to obtain updates or program releases that may not be available prior the beginning of the event being serviced by the system 10. Examples of service data include:
   a) Data for setting the software running each handheld electronic device 16. (For the purpose of this specification “setting” means either altering the software that may already be in the electronic device 16 or loading new software that was not present in the electronic device 16). For example, the service data may be used to set the user interface of the each handheld electronic device 16. In a non-limiting example of implementation the user interface is a Graphical User Interface (GUI). The user interface setting can be effected in order to customize the handheld electronic devices 16 for the local event. For instance, data can be sent to the handheld electronic device 16 that forms a menu on the handheld electronic device 16. The menu is such as to provide the spectator with a list of options. Another GUI component that can be customized or tailored for a particular event or venue is the graphical GUI information, such as background images on which other GUI elements can be displayed to the spectator. The service data may convey the Graphical User Interface (GUI) in multiple different languages so as to provide multiple language support to the users of the handheld electronic devices 16. In this manner, users of the handheld electronic devices 16 can select their language of preference. The choice of language may be presented to the spectators in an initial start-up screen that is displayed upon powering up the handheld electronic device 16. Specifically, the following components of the user interface can be set via the service data:
      i) Background image information;
         As discussed above this is the graphical information associated with the user interface.
      ii) Menu structure and look;
         This refers to the option items of the menu, in particular the options hierarchy, the options themselves (what are the options available to the spectator from which the spectator can select an action), the graphical elements of the menu, such as the disposition of the option items on the display, color and shape of the option items, etc.
      iii) Soft keys layout and look (soft keys will be discussed later);
         The aesthetical components of soft keys, such as their location on the screen, their shape, color, etc.
      iv) Soft keys assignments;
         The functions assigned to the respective soft keys
      v) Layout of icons on the display;
         The appearance and disposition of the icons on the display screen
      vi) Navigation mechanisms
         The type of navigation mechanisms to which the user interface responds, such as up, down, left and right arrows, pointing devices, voice recognition, etc.
   b) Cartographic data that can be used by the handheld electronic device 16 to display a map of the venue or a portion thereof. The cartographic data can be used in a standalone manner to show on the display of the handheld electronic device 16 a map of the venue that can be zoomed in or out to the desired degree of detail or panned to show different areas of the map. Alternatively, the cartographic data can be used in conjunction with a coordinates receiver, such as a Global Positioning System (GPS) receiver that can generate the coordinates of the location of the handheld electronic device 16. The coordinates can then be used to show on the display the map of the venue and point the location of the handheld electronic device 16. The cartographic data can also include specific locations of interest such as washrooms, vending stands, parking, etc. When the cartographic data is intended to work with location information generated by a GPS receiver or any other suitable device capable of producing location information it will typically be georeferenced. For maps that are not intended to work with devices producing location information, such georeferencing is not required since the map is processed simply as an image to be viewed by the spectator.

The head end station unit 82 organizes the data from the various inputs into a structured information stream for broadcasting to the individual handheld electronic devices 16. The head end station unit 82 has a video processor 102, an audio processor 104, a control entity 106 and a multiplexer 108. The control entity 106 includes a computing platform running a program to carry out various tasks. While not shown in the drawings, the computing platform includes a processor, memory to hold the program code and data that is being processed by the processor. In addition, the computing platform has a Graphical User Interface (GUI) 110 that provides a technician with the ability to send commands to the control entity 106 or to receive information therefrom. The GUI 110 can take various forms without departing from the spirit of the invention. For instance, the GUI 110 can include a display on which information is shown to the technician and a keyboard and mouse combination for data and commands entry.

The control entity 106 receives the various forms of information and will direct them to the appropriate encoders for processing. Specifically, all the video feeds that are received at the head end station unit 82 are handled by the video processor 102 that will convert the SDI format into Moving Picture Experts Group (MPEG)—4 format. Each video stream is compressed to provide at the handheld electronic device 16 a moving image at 30 Frames per second (fps), 16 bit colors at a 320×240 pixels resolution. The resulting bit rate is 384 Kbits/sec. Since the video processor 102 needs to handle multiple video feeds simultaneously it is designed in order to be able to process those feeds in parallel. The preferred form of implementation uses a plurality of encoder stations, each being assigned a video feed. The encoder stations can be based on dedicated video processing chips or purely on software, or a combination of both. Alternatively, the video processor 102 can use a single processing module with buffering capabilities to sequentially handle blocks of data from different video feeds. With an adequate size buffer and a processing module that is fast enough, all the video feeds can be encoded without causing loss of data.

Note that since MPEG-4 encoding also handles audio, the audio feeds that are associated with the respective video feeds are also directed to the video processor 102. The output of the video processor 102 is thus MPEG-4 encoded video channels where each channel has a video stream portion and an audio stream portion.

The independent audio feeds 35 that constitute the third input 300 are directed to an audio processor 104 that will encode them into a Moving Pictures Experts Group Audio layer 3 (MP3) format. Since the MP3 encoded audio streams convey voice information they can be compressed into an 8 Kbits/sec data rate while maintaining adequate quality. As in the case with the video processor 102, the audio processor 104 uses a series of audio encoding stations, each dedicated to a given audio feed. Alternatively, the audio processor 104 can use a single sufficiently fast encoding module having buffering capabilities to sequentially handle data blocks from all the audio feeds.

The control entity 106 handles the processing of the fourth, fifth, sixth and seventh inputs, namely the real time data, the authentication data, the ancillary content and the service data. The purpose of the processing is to packetize the data such that it can be transmitted to the individual handheld electronic devices 16.

The outputs of the control entity 106 and the video and the audio processors 102, and 104, are passed to a multiplexer 108 that combines the data into one common data flow. The data flow is then directed to an output 112. The data flow at the output 112 is organized in the form of packets. In a specific and non-limiting example of implementation, three types of packets are being sent. The first type includes the video information. In essence, the MPEG-4 information is packetized and transmitted. The video information packet includes a header that contains the relevant data allowing a handheld electronic device 16 to appropriately decode it and process it. Advantageously, error detection and correction data is also included in the header for a more reliable transmission. The second type of packet includes the independent audio information. The third type of packet includes the remainder of the payload, such as the ancillary information and the real and service type data. As in the case of the first type of packet, the second and third types of packets include identification data in the header to inform the handheld electronic device 16 what type of content the packet holds such that the content can be adequately processed.

The table below provides an example of data at the output 112 and the respective bit rate.

| | Required | | | |
|---|---|---|---|---|
| | unit bit | | Aggregated | |
| Description | rate | Number of feeds | bit rate | |
| Live video feeds 31, 320 × 240 | 384 Kbits/sec | 10 | 3.84 | Mbits/s |
| pixels, 16 bit colors, | | | | |
| 30 Fps (Mpeg 4) | | | | |
| Audio feeds 32 | 28.8 Kbits/sec. | 10 | 288 | Kbits/sec. |
| (synchronized with video | | | | |
| feeds-MP3) | | | | |
| Independent voice grade | 8 Kbits/sec. | 48 | 384 | Kbits/sec. |
| compressed audio feeds | | | | |
| 35 (MP3) | | | | |
| Real time data 37 - 6,000 | 480 Kbits/sec. | 1 | 480 | Kbits/sec. |
| ASCII Characters (or | | | | |
| equivalent data payload) of | | | | |
| high priority refresh | | | | |
| Ancillary content and | 1 Mbits/s | 1 | 1 | Mbits/sec. |
| service data, (several | | | | |
| priority refresh levels) | | | | |
| Authentication data | 256 bits/30 sec. | 50,000 | 425 | Kbits/sec. |
| Spare | | | ≈1 | Mbits/sec. |
| Overall payload | | | 7.5 | Mbits |

As mentioned previously, the head end station 80 includes a number of head end station units 82 identical to the number of sites that are being serviced by the system 10. In the present case, there are three head end station units 82, associated with the sites A, B and C, respectively. Each head end station unit 82 issues a data flow at its output 112 that is directed to the respective site. FIG. 3 illustrates the collective output of the head end station 80. For clarity, the output is shown as three separate data streams, designated as 112A, 112B and 112C that are directed to sites A, B and C, respectively.

The data streams 112A, 112B and 112C may be identical but for most applications they will carry different content. The content may differ in terms of video streams, associated audio streams and independent audio streams, which is determined largely by the mixing operation performed at the content production station 54. If every video, associated audio and independent audio stream from a venue is distributed to every other site, ultimately the video, associated audio and independent audio streams in the data streams 112A, 112B and 112C will be the same. When a more limited mixing is performed then the data streams 112A, 112B and 112C will be different.

The most likely difference, however, between the data streams 112A, 112B and 112C is at the level of the ancillary content. Since in most applications the ancillary content is likely to be venue specific, this distinction will be reflected in the data streams 112A, 112B and 112C. More specifically:
1. Advertisement content. The advertisement content may or may not be different. One possibility is to deliver the same advertisement content to two or more sites that are serviced by the system 10. Another possibility is to tailor the advertisement for every venue or group of sites. In this form of implementation, the data streams 112A, 112B and 112C will carry different advertisement content.
2. Venue or event related contextual information. The venue or event related contextual information is likely to be different from one data flow 112A, 112B and 112C to another since it is venue specific. One instance where the venue or event related contextual information is the same is when each data flow 112A, 112B and 112C carries venue or event related contextual information for every site, leaving the spectator to make a selection on the handheld electronic device 16.
3. News. The news content may be different or identical depending on the type of news that is delivered. For “national” news that are relevant for each site, the news content in the data streams 112A, 112B and 112C is likely to be the same. However, if the news are “local” and specific to each venue then they are likely to be different from one data flow 112A, 112B and 112C to another. Again, the possibility exists to carry in each data flow 112A, 112B and 112C separate local news streams, where each local news stream is relevant for a different site, leaving the spectator to select what is of interest.
4. Environmental conditions. The environmental conditions are likely to be different in each data flow 112A, 112B or 112C since the environmental conditions are venue specific. Here again the possibility exists to carry in each data flow 112A, 112B and 112C separate environmental conditions streams, where each environmental conditions stream is relevant for a different site, leaving the spectator to select what is of interest.
5. Shopping information. The shopping content may be the same for each data flow 112A, 112B or 112C but it is likely to be different. In most applications the shipping information content will be venue specific, such as for example relating to paraphernalia about the teams that play at that site. As indicated earlier the possibility exists to carry in each data flow 112A, 112B and 112C separate shipping information streams, where each shipping information stream is relevant for a different site, leaving the spectator to select what is of interest.

Another likely difference between the data streams 112A, 112B and 112C is at the level of the service data. Since the service data is likely to be at least to some extent venue specific, it will be different from one data flow 112A, 112B and 112C to another. Differences could be at the following levels:
1. The data for setting the user interface of the handheld electronic devices 16. Since the user interface is likely to be venue specific, then the data setting the user interface in each data flow 112A, 112B and 112C is likely to be different. For instance, the user interface setting data determines a menu of choices that is related to the local teams playing the game. The menu of choices can include a list of players or teams on which detailed information can be accessed by the spectator. Since different players or teams participate in the game at each site, the menu of choices for that site's handheld electronic devices 16 is different from the menu of choices for handheld electronic devices 16 of another site. Similarly, the background graphical information for the GUI may be venue specific. More generally, the following components of the user interface can be customized:
   a. Background image information;
   b. Menu structure and look;
   c. Soft keys layout and look (soft keys will be discussed later);
   d. Soft keys assignments;
   e. Layout of icons on the display;
   f. Navigation mechanisms.
As with the examples discussed earlier, it is also possible to convey in the data flows 112A, 112B and 112C user interface setting data suitable for each site, and providing the handheld electronic device 16 with functionality to select and make use of the relevant data and disregard the rest.
2. Cartographic data. The cartographic data is likely to be different among the data flows 112A, 112B and 112C since it is venue specific. Again the possibility exists to send in each data flow 112A, 112B and 112C cartographic data for each site, leaving the user of the handheld electronic device 16 to make the relevant selection.

Yet another possible difference between the data flows 112A, 112B and 112C is the authentication data. Depending on the specific authentication scheme used, the authentication data in each data flow 112A, 112B and 112C could be different and specific to the population of handheld electronic devices 16 at the venue A, B or C associated with that data flow 112A, 112B and 112C. Alternatively, the authentication data can be the same in each data flow 112A, 112B and 112C.

The databases 502, 602 and 701 are designed to provide the relevant, authentication data, ancillary data and service data to each head end station unit 82. For instance, there may be databases 502, 602 and 701 that are associated with a specific head end station unit 82, when the data they provide is venue specific. Although the drawings show architecture where the databases 502, 602 and 701 are shared among the head end station units 82, this is only for the purpose of simplified illustration. The present invention encompasses both options, namely a shared set of databases 502, 602 and 701 and multiple database sets 502, 602 and 701 that are venue specific.

Referring back to FIG. 3, the head end station 80 is shown as outputting the data flows 112A, 112B and 112C that are in turn input in the data network 14. The data network delivers those data flows 112A, 112B and 112C to the sites A, B and C, respectively. With reference to FIG. 2, the data flow 112A is delivered at output 15, supplied to a modulator 17 and then to transmitter 18. The modulator 17 and the transmitter 18 produce a wireless RF broadcast that uses a 6 MHz contiguous channel bandwidth, centered at 2.5 GHz to broadcast the digital data flow 112A to the handheld electronic devices 16 at venue A. Alternatively, the transmission may also be made in the Ultra High Frequency (UHF) range, specifically in the sub range of 470 MHz to 806 MHz. A 6 MHz contiguous bandwidth (equivalent to one regular TV channel) is sufficient to transmit the exemplary payload indicated earlier. The digital data flows 112B and 112C are broadcast in the same manner in the respective sites, as described in connection with venue A.

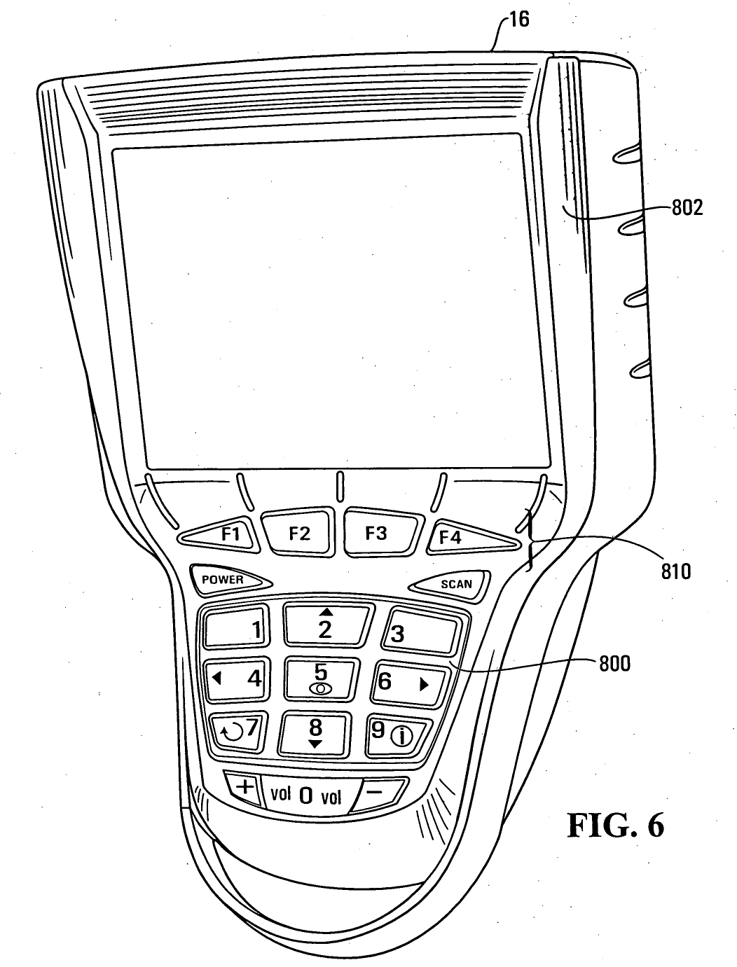

FIG. 6 shows a perspective view of the handheld electronic device 16 that can be used in any one of the sites A, B and C to pick up the local wireless RF broadcast. The handheld electronic device 16 is portable and designed to fit comfortably in the spectator's hand. It includes a keyboard 800 with the necessary keys to control the operation of the handheld electronic device 16. Above the keyboard 800 is provided a display section 802 in which is placed a display screen.

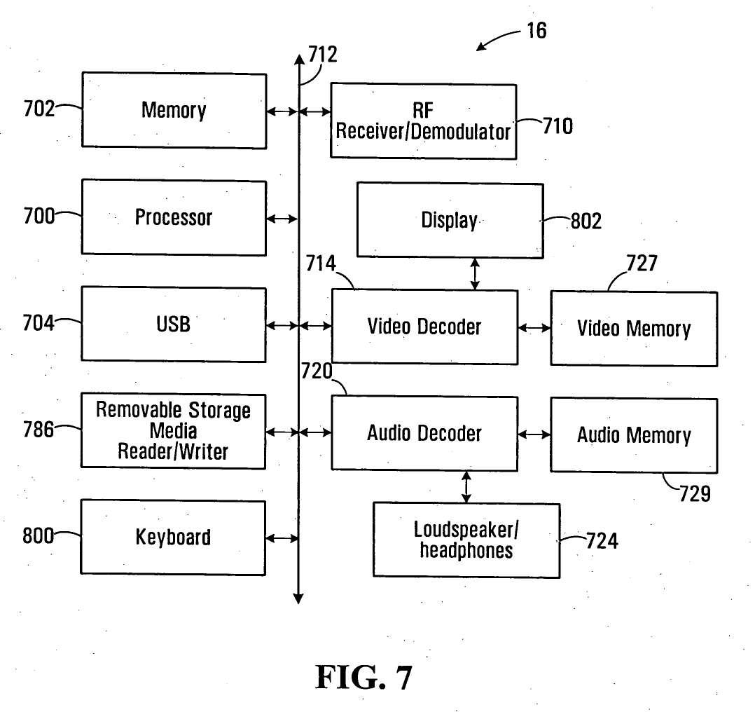

FIG. 7 is a block diagram of the handheld electronic device 16. The handheld electronic device 16 is a computer-based apparatus that receives the information sent by the transmitter 18. The video information is displayed on the display screen 802 and the audio information is played via suitable speaker/headphones 724. The spectator can control the selection of the video channels as well as to perform other operations. By video channel at the handheld electronic device 16, it is meant a combination video stream and an associated audio stream.

As seen in FIG. 7, the handheld electronic device 16 has a processor 700 that executes software for controlling the various functions of the handheld electronic device 16. Generally, the software has four main layers, namely:

The Configuration Layer
The configuration layer allows the user or the manufacturer to set characteristics of the handheld electronic device 16, such as enable or disable options, language, time, passwords, etc.

The GUI Layer
In the example described in this specification the GUI includes a graphical and navigation layer that allows the spectator to access specific functions of the handheld electronic device 16. The GUI would typically present to the spectator on the screen options, such as menus that the spectator can navigate to access the feature that is desired. As indicated earlier, the service data portion of the data flow 112A, 112B and 112C broadcasted by the transmitter 18 contains information that determines how the graphical and navigation layer will appear to the spectator. The following are examples of the types of GUI components the service data portion can set on the handheld electronic device 16:
   i. Background image—an image that appears on the screen and on which are overlaid other types of information such as menu choices. For instance the background can have a visual theme associated with the event or venue A, B and C. The background image can change for different events or sites;
   ii. Menu structure—define the options hierarchy that is available to the spectator. For example, for a certain event, 10 video channels or other options are available but for other events, fewer or more channels or options are possible.
   iii. Menu look and details—the visual appearance and prompts associated with the various menu choices. For instance, the different video channels may have names or identifiers associated therewith, such as the video channel from the left side of the football field, the video channel from the right side of the football field, etc. Also the different menu options can have different colors, different shapes or dispositions on the display.
   iv. Soft keys assignment—Referring briefly to FIG. 6, the handheld electronic device is provided with Function keys 810 (F1, F2, F3 and F4). The user interface may assign different functions to each physical key F1, F2, F3 or F4. In a specific and non-limiting example of implementation, the current assignment of a key is displayed on the display 802, immediately above the associated physical key (F1, F2, F3 or F4).
   v. Soft keys layout and look—The aesthetical components of soft keys, such as their location on the screen, their shape, color, etc.
   vi. Layout of icons on the display—The appearance and disposition of the icons on the display screen.
   vii. Navigation mechanisms—The type of navigation mechanisms to which the user interface responds, such as up, down, left and right arrows, pointing devices, voice recognition, etc.
      In a non-limiting example of implementation, the data for setting the GUI in the handheld electronic device 16 is sent during a window of operation that precedes the beginning of the wireless RF transmission of the video channels. For instance, in the context of a football game, this can be done before the game event starts. In a second example, the data for configuring the GUI is sent before and during the game along the rest of the payload, such as along the video channels. As far as the handheld electronic device 16 is concerned, after the data for configuring the GUI is received it is loaded such that the spectator is presented with the new GUI. When an authentication process is required to allow the handheld electronic device 16 to access the video channels, as will be described later, the actual loading of the new GUI can be deferred until the authentication has been completed.

The Baseline Code
In a specific and non-limiting example of implementation, a LINUX kernel is used to provide common core services, such as memory management, task scheduling and user interfacing, among others.

Basic Firmware
Software embedded into hardware to control the hardware. For instance, the algorithms to decode the video and audio information broadcasted by the transmitter can be implemented in hardware.

The software is stored in a general-purpose memory 702. Typically, the memory 702 would include a Read Only Memory (ROM) portion that contains data intended to be permanently retained such as the program code that the processor 700 executes. In addition, the memory 702 also includes a Random Access Memory (RAM) portion that temporarily holds data to be processed. The memory 702 can be implemented as a single unit, for instance as a semiconductor-based module or may include a combination of a semiconductor-based module and a mass-storage device, such as a hard-drive.

A Universal Serial Bus 704 (USB) port is provided to allow the handheld electronic device 16 to connect to external devices. Specifically, the USB port 704 allows linking the handheld electronic device 16 to a computer that can either download information from the handheld electronic device 16 or upload data to it. For instance, the download process may be used when desired to transfer data stored in the memory 702 to the external computer. Similarly, an upload process is used to perform the reverse operation. This is useful when desired, for example, to change the program running the handheld electronic device 16, by installing one or more updates. The USB port 704 requires a suitable driver that is loaded and executed by the processor 700 when the handheld electronic device 16 is powered up.

A removable storage media reader/writer 786 is provided to allow the handheld electronic device 16 to read data or write data on a removable storage media such as a memory card. This feature can be used to permanently record event-related content that is sent to the handheld electronic device 16. This functionality will be discussed later in greater detail.

As indicated earlier, the keypad 800 allows the spectator to control the operation of the handheld electronic device 16. The number and type of keys forming the keypad 800 is a matter of choice depending upon the specific application. As a possible variant, a touch sensitive screen or a voice recognition capability can be used to replace the keypad 800 or in combination with the keypad 800 as a means for command and data entry by the spectator.

The handheld electronic device 16 has an RF receiver and demodulator 710 that senses the wireless RF broadcast transmission, demodulates it and delivers it as properly organized and formatted data blocks to a data bus 712. The data thus sent over the data bus 712 is made available to the memory 702, the processor 700, the USB port 704 and the removable storage media reader/writer 706. In a specific example of implementation, the RF receiver and demodulator 710 operates in the 2.5 GHz range. Alternatively, the transmission may also be made in the Ultra High Frequency (UHF) range, specifically in the sub range of 470 MHz to 806 MHz. A 6 MHz contiguous bandwidth (equivalent to one regular TV channel) is sufficient to transmit the exemplary payload indicated earlier.

A video decoder 714 is provided to perform the decoding of the video channels received from the RF receiver and demodulator 710. For clarity it should be mentioned that while the specification refers to the decoder 714 as “video” decoder it also performs audio decoding on the audio information associated with the video channels. The video decoder 714 has a memory 727 in the form of a buffer that will hold undecoded video/audio information representing certain duration of video channel play. For instance the size of the buffer may be selected such that it holds 5 minutes of video channel play, for each channel. In use the video/audio information not yet decoded that is received from the RF receiver and demodulator 710 is sent over the data bus 712 to two locations (1) the video decoder 714 and (2) the memory buffer 727. The video decoder 714 decodes the video/audio information and then directs it to the display screen 802 to be viewed by the spectator. At the same time the undecoded video/audio information that is directed to the memory buffer 727 starts to fill the memory buffer 727. When the memory buffer 727 is completely filled, it starts overflowing such that only the last 5 minutes of the video channel play are retained. The same operation is performed on every video channel, with the exception that only the video channel the spectator wants to watch is being decoded and directed to the display screen 802. Accordingly, the memory buffer 727 is segmented in the functional sense into areas, where each area is associated with a video channel.

The audio stream that is associated with the video stream being watched is decoded, converted into an analog format, amplified and directed to speaker/headphones 724 such that the spectator can watch the video stream on the display screen 802 and hear the associated audio simultaneously.

The ability to retain the last five minutes of video channel play provides the spectator with interesting possibilities. For instance, the spectator can manipulate the data in the memory buffer 727 so as to “playback” a certain video channel content, create fast forward motion, “rewind” motion and record the video/audio information in the memory buffer 727, either in part or the entire content by copying it on a storage media in the removable storage media reader/writer 786. In this fashion, the video/audio information of interest to the spectator can be permanently retained. Moreover, the spectator can see any action that may have been missed by switching channels and then “rewinding” the content of the memory buffer 727 associated with the newly selected channel.

It is generally found suitable to use a memory buffer 727 in the form of a semiconductor based unit. In applications where large memory capacity is required in order to store a large video content, a storage device such as a hard drive can be used.

The display screen 802 can be of any suitable type. One possibility is to use a 3.5 in diagonal transrelfective Thin Film Transistor (TFT) screen capable of rendering 320×240 pixel resolution images with 16 bit color depth. Evidently, other display types can be used without departing from the spirit of the invention. Optionally, the handheld electronic device 16 can be provided with a lighting system (not shown in the drawings) using Light Emitting Diodes (LEDs) or any other suitable illumination technology to facilitate viewing under low light level conditions.

The audio decoder 720 functions in a somewhat similar manner to the video decoder 714. Specifically, the audio decoder 720 is associated with an audio memory buffer 729 and it handles the independent audio streams conveying the audio information from the independent audio feeds 35. The independent audio streams are stored in a compressed format in the audio memory buffer 729 so as to record a predetermined period of the audio content that is received.

By storing the audio content received by the handheld electronic device 16 over a time period determined by the capacity of the audio memory buffer 729, the spectator is provided with the ability to “playback” the audio content, create “fast-forward”, “rewind” and bookmarks. In addition, the audio information in the audio memory buffer 729 can be recorded either in part or in its entirety by copying the content on a storage media in the removable storage media reader/writer 786.

The functionality of the handheld electronic device 16 will now be discussed in detail.

### 1. Handheld Electronic Device Authentication

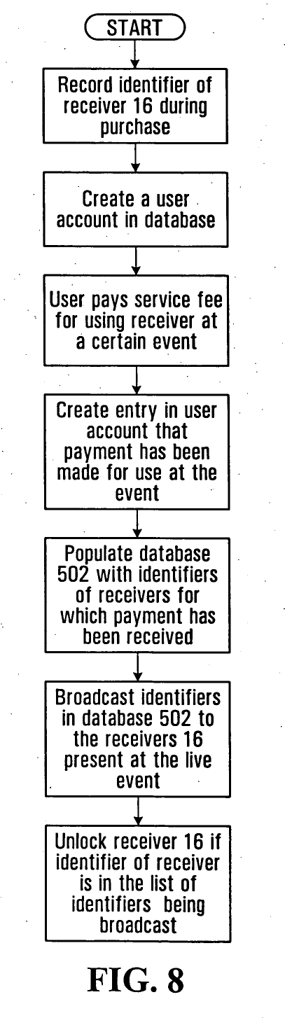

The flowchart in FIG. 8 illustrates the general handheld electronic device 16 registration process that also covers the authentication feature. When the spectator purchases the handheld electronic device 16 the vendor will record the unique identifier of the handheld electronic device 16. The identifier can be any code such as a string of numbers or characters that is assigned to the handheld electronic device 16 such that it can be distinguished from other handheld electronic devices 16. Typically, the identifier is a binary code that is permanently stored in the handheld electronic device 16 and thus unalterable. The processor 700 can readily access this binary code when the handheld electronic device 16 is in use. For convenience this unique identifier can be placed on a removable sticker on the handheld electronic device 16 or on the box in which it is shipped from the manufacturer. The identifier can be printed as a bar code, appear as alphanumerical characters or both. In this fashion the clerk performing the transaction can record easily the identifier without having to extract it from the handheld electronic device 16.

At the next step, once the identifier has been recorded, the vendor will typically create a user account in a database. The user account will allow the spectator to purchase the delivery of content to the handheld electronic device 16. In the example described in FIG. 8, the spectator purchases content access on an event basis. In other words, for each event the spectator wishes to attend, the spectator will make a payment and the delivery of service will only be available for that event. Evidently, other options exist. For example, the spectator may purchase access to content on a subscription basis, such as to have access to content over a predetermined period of time for all events within that period. In addition, the account may be designed to allow for different levels of service, such as basic or high grade. A higher grade service, for example, offers features to the user not available under the basic level.

Continuing with the above example, assume that the spectator now whishes to have access to content on the handheld electronic device 16 for a certain live sporting event that the spectator plans to attend. The spectator then makes the payment to his account. The payment can be made in person, to a kiosk or at any other location authorized to receive payments. Advantageously, electronic payment methods, such as over the Internet, can be used. With such a method the spectator logs on to an Internet site of the service provider and makes the payment via credit card or other. The payment process will typically include selecting the event or group of events for which access to content is desired, the level of service, if applicable, and then making the payment. When the payment is made and validated an entry is automatically made in the user account indicating that access to content (in full or in part) for the handheld electronic device 16 specified in the account is enabled.

At the event itself, before starting to broadcast the content to the individual handheld electronic devices 16, the database 502 connects to the network of the service provider over the Internet such that the database 502 can be populated with the identifiers of all the handheld electronic devices 16 for which payment for content delivery for the event has been made. Once this step is completed all the handheld electronic device 16 identifiers in the database 502 are transmitted to the head end station 80 such and they are then all included in the broadcast that is made by the transmitter 18. Specifically, the block of identifiers are broadcasted periodically, say every minute such as to allow the individual handheld electronic devices 16 to perform the authentication process at any time.

Since the operation of the system involves several sites, the authentication process creates a site-specific group of identifiers to be broadcast, for each venue A, B and C. For instance, the identifiers of the handheld electronic devices 16 that have purchased access to the service in relation to the football game played on venue A are all placed in a group associated with that site. The same operation is performed for all the other sites, namely sites B and C. Each site-specific group of identifiers is then placed in the respective data flow 112A, 112B and 112C. As indicated previously, another option is to create a common group of authentication number that encompasses all the handheld electronic devices 16 that have purchased service for the events in any one of the sites A, B and C. That common group is then placed in each data flow 112A, 112B and 112C.

Each handheld electronic device 16 is designed such that it cannot operate unless it has been electronically unlocked. When the handheld electronic device 16 is powered up, it automatically enters the locked mode. During the locked mode the handheld electronic device 16 will acquire the wireless RF transmission and decode the information such as to extract the block of identifiers that are being sent. Once the block of identifiers is extracted from the transmission the handheld electronic device 16 will compare each number from the block to the identifier of the handheld electronic device 16. If a match is found, then the handheld electronic device 16 enters the unlocked mode and the content that is being broadcast can be adequately received. However, if no match is found after a certain period, say 2 minutes the handheld electronic device 16 shuts down automatically.

The approach described earlier is a simple way to ensure that content is delivered only to handheld electronic devices 16 that are authorized to receive the service, in particular belonging or being used by spectators that have made payment, since no encryption of the video/audio content is required. In addition, the delivery of the authentication information to the individual handheld electronic devices 16, such as the block of identifiers, in a wireless manner, is simple from a logistics standpoint.

For enhanced security, the block of identifiers that are being transmitted can be encrypted using any suitable encryption techniques. The handheld electronic device 16 should, therefore be provided with capability to decrypt the block of identifiers by using a suitable key.

Another option is to encrypt the entire transmission and require the handheld electronic device 16 to decrypt it. In this form of implementation, the encryption constitutes the authentication data carried by the wireless RF transmission that is processed by the individual handheld electronic devices 16. A decryption key or password may need to be input by the spectator. In such case, a decryption key may be provided to the spectator following the payment for the service. When the spectator powers up the handheld electronic device 16, the spectator enters the key and that key is used to perform the decryption.

If encryption or decryption is required, the function can be implemented at the handheld electronic device 16 by suitable software or hardware, both of which are known in the art.

The authentication described earlier can be modified such as to provide service level access control. As it will be discussed later, the handheld electronic device 16 can be designed in such a way as to deliver to the spectator service available in different levels or categories. The levels can be distinguished from each other on the basis of content, for example. The basic level of service may include basic content, such as for example a limited number of video channels. A higher level of service may include a larger number of video channels and contextual information or other content. The reader will appreciate that the distinguishing characteristic of the different service levels will vary in accordance with the intended application. Generally, the higher the service level, the richer the content it provides to the spectator.

The service levels are likely to be available at different cost to the spectator. More specifically, the basic level of service is likely to be the least expensive and as content options are added to upgrade to a higher level of service then the cost to the spectator will increase.

It is desirable to provide the handheld electronic device 16 with an authentication feature that will allow the handheld electronic device 16 to provide to the spectator access to the level of service the spectator has paid for and thus protect the wireless RF transmission from unauthorized access to content or service levels that have not been purchased.

One possible option is to create, when the spectator purchases the service, distinct lists of identifiers for each service level that is available. Assume that three service levels are available, namely service level A, service level B and service level C. Service level A is the basic and the least expensive. Service level B is the intermediate level and includes features not available under service level A, for example more video channels and a limited amount of contextual information. Service level C is the highest and it provides the richest content, namely the largest number of channels and the most contextual information. As the service is being purchased by spectators, three different lists of electronic identifiers are created, one for those that have purchased service level A, one for those that have purchased service level B and one for those that have purchased the service level C.

Under this example, the wireless RF transmission is structured in a way to maintain a distinction between the different levels of service. For example, a core block of frames carries the content for the service level A, which is the basic level. A first additional block of frames carries the additional content that is added to the service level A to upgrade to service level B. Finally there is a second additional block of frames that carries the additional content added to service level B to upgrade to service level C. In such case, the service level C encompasses the content of service levels B and A, while the service level B encompasses the content under service level A.

The authentication information sent to the handheld electronic devices 16 is organized into groups as well. There is a first group that contains the list of the identifiers of the handheld electronic devices 16 for which service at level A has been purchased, a group with a list of the identifiers of the handheld electronic device 16 for which service at level B has been purchased and a group with the list of the identifiers of the handheld electronic devices 16 for which service at level C has been purchased.

As a handheld electronic device 16 picks up the wireless RF transmission, it will, as discussed earlier, try to find in anyone of the lists its own electronic identifier. If the identifier is not found in anyone of the lists, then the handheld electronic device 16 will not unlock itself and the spectator will not be able to access the content. However, the handheld electronic device 16 will unlock itself if its identifier is found in anyone of the lists. If the identifier is found in the list for service A, then the spectator will be able to view only the content carried in the core block of frames, the one that is associated with the service level A. Access to frames associated with any other service level will not be allowed. The control is implemented by the handheld electronic device 16 that determines which part of the wireless transmission it can make available to the spectator. Since the different block of frames are clearly distinguished from one another and associated with the respective groups of identifiers, the determination of the groups where the identifier of the handheld electronic device 16 resides, allows controlling the access to the relevant block of frames that hold the content. If the identifier is in the group associated with the core block of frames, only those will be processed and in effect the spectator will have only access to the service at level A. If the identifier of the handheld electronic device 16 is located in the group associated with the first additional block of frames then only the core block and the additional bloc will be processed, in effect limiting access to the content at level B. Finally, if the identifier of the handheld electronic device 16 resides in the group associated with the second additional block of frames, then full access to the entire content is granted.

The examples of the authentication feature described above are relatively simple to implement. However, there is a need to carry in the wireless RF transmission the entire list of the electronic identifiers of the handheld electronic devices 16 that are allowed to receive content. If a large number of handheld electronic devices are being serviced by the wireless RF transmission, the number of electronic identifiers that need to be transmitted may grow too large to be practical.

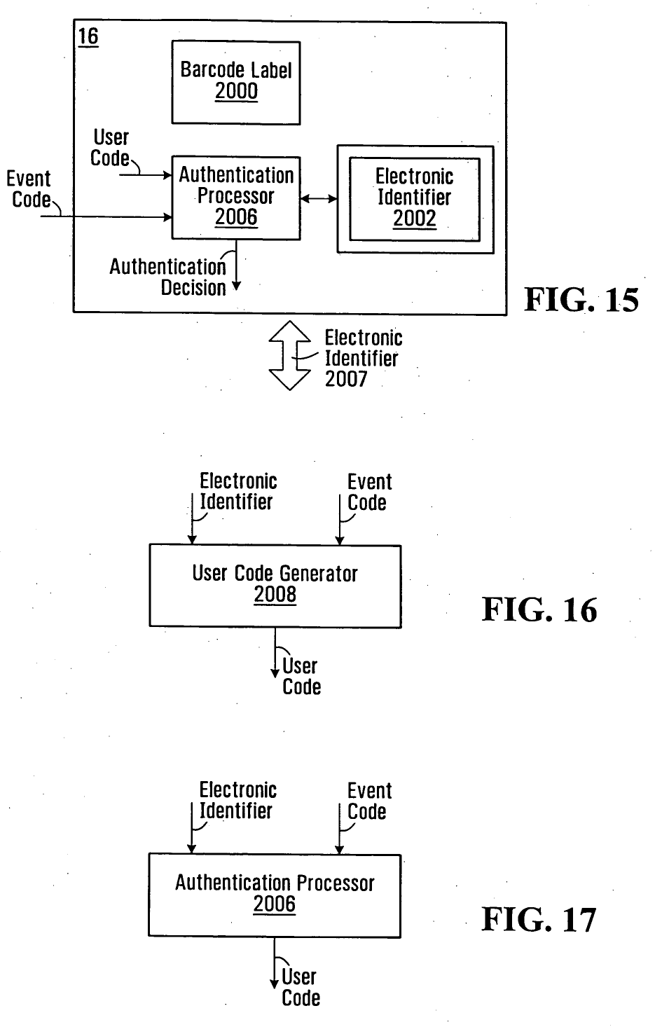

FIGS. 15 to 17 illustrate a variant in which it is not necessary to include in the authentication information in the wireless RF transmission a complete list of the handheld electronic receivers 16 allowed accessing the content in the wireless RF transmission. FIG. 15 shows a high level block diagram of the handheld electronic device 16 illustrating the storage area (which includes the memory 702 in addition to any other storage, either volatile or not volatile). The non-volatile portion of this storage area holds the electronic identifier described earlier. In this drawing the electronic identifier is designated by the reference numeral 2002.

The handheld electronic device 16 is also provided with a bar code 2000 on its casing that is machine readable, such as by using a bar code reader (not shown). The bar code is a representation of the electronic identifier 2002. Note that the label holding the bar code may also contain another form of representation of the electronic identifier 2002, such as for example, by using alphanumeric characters suitable to be read by a human.

It is also possible to apply on the casing of the handheld electronic device 16 a bar code 2000 that is not identical to the electronic identifier 2002. In other words, the electronic identifier 2002 and the bar code 2000 are different codes. Some embodiments of the authentication process described later require access to the electronic identifier 2002 via the bar code 2000. In the embodiment where the electronic identifier 2002 and the bar code 2000 are the same codes then a reading of the bar code 2000 will yield the electronic identifier. However, when they are different codes, a mapping mechanism can be used to relate one to the other. The mapping mechanism can be a database storing all the population of electronic identifiers 2002 and the respective bar codes 2000. When it is necessary to obtain an electronic identifier 2002 of a certain handheld electronic device 16, the bar code 2000 is read, the database searched and the corresponding electronic identifier 2002 retrieved.

The handheld electronic device 16 also includes an authentication processor 2006. The authentication processor 2006 is designed to handle authentication related tasks, such as for example output the electronic identifier 2002 to an external device (as it will be described later), process a user code entered by the spectator and the authentication information contained in the wireless RF transmission to electronically unlock the handheld electronic device 16 to allow the spectator to gain access to the content in the wireless RF transmission. The authentication processor 2006 is likely implemented in software but it can also be implemented in hardware by a specialized circuit. A combination of software and hardware is another option.

When a spectator desires to purchase the delivery of service to the handheld electronic device 16, the spectator performs the transaction by interacting with an external entity which generates a user code. At the live event, the spectator enters via the user interface the user code provided earlier. The authentication processor 2006 performs a validation of the user code information provided by the spectator and issues an authentication decision. The authentication decision is conveyed by any suitable internal signal which will have the effect to allow the spectator to gain access to the content in the wireless RF signal, if the user code is a correct code, or to deny this access when the user code is a wrong code. For instance, the signal that conveys the authentication decision can be designed to enable the processing of the content in the wireless RF transmission such that it can be viewed and/or heard by the spectator, when the authentication decision validates the user code. On the other hand, when the authentication decision does not validate the user code, then the internal signal is designed to prevent content from being made available to the spectator. The authentication decision issued by the authentication processor 2006 can also be designed to handle levels of service. In such case, the authentication decision indicates which level of service the handheld electronic device 16 is entitled to receive, if any.

A block diagram of the external entity is shown in FIG. 16. More specifically, the external entity has a user code generator 2008 which receives as inputs the electronic identifier 2002 and the event code. The user code generator 2008 processes these entries by any suitable function which produces the user code. The function uses as parameters the electronic identifier 2002 and the event code and processes them mathematically. The user code is the result of the mathematical processing. The mathematical processing itself is not critical to the invention and many different mathematical functions can be used without departing from the spirit of the invention. One desirable property of the mathematical processing is that it should be non-reversible. By non-reversible is meant that knowledge of the user code does not allow reconstructing the electronic identifier 2002, nor the event code, nor the mathematical function used to generate the user code based on the two inputs.

The user code generator 2008 can, for example, be implemented at a booth at the live sporting event the spectator plans attending. The attendant at the booth receives payment from the spectator, the amount of which may be dependent on the level of service desired. The attendant then places adjacent the handheld electronic device 16 a reader such as an infrared reader to interact with an infrared port (not shown in FIGS. 15 to 17) on the handheld electronic device 16. The infrared reader and the handheld electronic device 16 establish communication and the authentication processor 2006 releases over the infrared link the electronic identifier 2002. The infrared link is depicted in FIG. 15 by the large arrow 2007. Alternatively, communication between the handheld electronic device 16 and the reader can be established by using a wireline connection such as via a USB port, or any other suitable arrangement.

The electronic identifier is supplied to the user code generator 2008 in addition to the event code which is available to the user code generator 2008. Normally, the same event code is used for every handheld electronic device 16 for which service is being purchased. The event code is a code that designates the event for which service is being purchased, while the electronic identifier is a code that distinguishes one handheld electronic device 16 from another. In a specific example of implementation the event code will typically be different from one event to another. For instance, in the case of football games played at different sites, each football game will be associated with a different event code.

The user code generator 2008 will process the two entries according to the desired mathematical non-reversible function and outputs the user code. In this particular case, the mathematical processing is a succession of mathematical operations on the two entries that produce a user code that is smaller (less digits) than both the event code and the electronic identifier 2002. The user code is given to the spectator in any convenient way. It may be printed, for instance on a ticket and remitted to the spectator. Normally, this code will be unique to each handheld electronic device 16.

Note that it is also possible to implement the user code generator 2008 to produce user codes for different handheld electronic devices 16 without establishing an electronic communication with the handheld electronic devices 16. This can be done by using a bar code reader for reading the bar code 2000 on the casing of each handheld electronic device 16. If the bar code 2000 is the same as the electronic identifier 2002 then the processing by the user code generator 2008 can be effected as described earlier. Otherwise, if the bar code 2000 is different from the electronic identifier 2002, a database (not shown) mapping the bar codes 2000 to the electronic identifiers 2002 of the population of the handheld electronic devices 16 is searched to extract the electronic identifier 2002 corresponding to the bar code 2000 that was read.

As the spectator enters the stadium, the spectator turns the handheld electronic device 16 on and he is requested by the authentication processor 2006 to supply a user code. The request may be, for example, a prompt appearing on the display 802 of the handheld electronic device 16 to enter a user code (assuming that the system requires manual input of the user code). The spectator enters the user code printed on the ticket via the user interface of the handheld electronic device 16. As shown in FIG. 17, the authentication processor 2006 to which are readily available the electronic identifier 2002 and the event code that is conveyed in the wireless RF transmission, processes the electronic identifier 2002, and the event code according to the same mathematical function implemented by the user code generator 2008. If the output of the process issues a code that matches with the user code entered by the spectator, then the authentication processor 2008 issues an authentication decision allowing access to the content in the wireless RF transmission. Otherwise, access to the content is denied.

In the context of a multi-site arrangement, the authentication data that is conveyed in the data flows 112A, 112B and 112C is different from one another, since each data flow carries a different event code.

A possible option is to communicate the user code to the handheld electronic device 16 electronically, immediately after the electronic identifier 2002 is communicated to the user code generator 2008. As soon as the user code generator 2008 computes a user code, that code is conveyed via the communication link 2007 to the authentication processor 2006. This option obviates the need for the spectator to manually input the user code for validation purposes. The electronic transaction automatically unlocks the handheld electronic device for use at the live sporting event, without the necessity for the spectator to input any user code.

In a possible variant, the user code is provided to the spectator via an online purchase set-up that can be made any time before the live event begins. Briefly, the spectator accesses the Internet via a personal computer or any other communication device and connects with a web site where an on-line purchase of delivery of service can be made. The server hosting the web site implements the user code generator and computes a user code. The user code that is produced is communicated to the user, such as by displaying it on the screen of the personal computer, sent to the user by e-mail to a specified e-mail address or via any other suitable fashion. The user will retain the user code and enter it in the handheld electronic device 16 during the live event.

Another possible option that can be considered is to convey in the wireless RF transmission, the event code (as in the previous embodiment) and also all the user codes for the handheld electronic devices 16 for which service has been purchased. This option would require computing for every handheld electronic device 16 for which service is purchased (for example at the point of purchase of the service) a user code and storing all the user codes so computed into a database. Note that this operation can be implemented on a site by site basis, such that the RF transmission in a given site only conveys the event code and the user codes relevant for the population of electronic receivers 16 at that site. During the live sporting event, the content of the database is periodically broadcasted along with the event code. Each handheld electronic device 16 that is at the live sporting event receives the wireless RF transmission and extracts the event code. The event code is then used to compute a user code by the authentication processor 2006. That user code is then checked against the set of user codes contained in the wireless RF transmission. If a match is found the authentication processor 2006 issues an authentication decision allowing the handheld electronic device 16 to access the video/audio content in the wireless RF transmission. If no match is found then the handheld electronic device 16 remains locked.

The various embodiments described above that employ a user code for authentication purposes can also be adapted to a multi-service level arrangement. In the case of a multi service level system, the spectator will be provided with a different user code depending on the particular service level that was purchased. The wireless RF transmission has content that is structured to distinguish one service level from another and each service level is associated with different authentication information. The authentication information is a compound event code including a plurality of service level codes that are different from one service level to another. Accordingly, in this example, the authentication information will contain as many service level codes as there are different service levels. In use, the authentication processor 2008 will try to match the user code supplied by the spectator to the compound event code. Specifically, the authentication processor 2008 will issue an authentication decision to unlock the handheld electronic device 16 when a match is established between the user code and any one of the service level codes, but the authentication decision will control the access to the content, as discussed earlier, such that the spectator will only be able to gain access to the service level that was purchased.

Note that the event codes (either a unique code or a compound code in the case of a multi-level approach) are generated by the authority or organization controlling the delivery of service to the spectators during the live event. Those codes can be randomly generated for every new event.

### 2. Video Stream Reception and Related Functions.

Assuming that the authentication process described earlier has been successfully passed, the graphical and navigational layer is loaded and the user interface that allows the spectator to access the various functions is presented on the screen. Typically, the user interface presents a menu that will show a list of choices. The spectator navigates the menu by operating keys on the keyboard. Those keys may be arrow keys or any other suitable keys. When a selection has been made the choice or option is activated by pressing any suitable key such as an “enter” key.

The menu options available to the spectator can vary significantly according to the intended application. The description provided below illustrates a few possible examples.
Watching a video channel—the spectator will access this choice and activate it. The menu hierarchy is designed so as to display the list of the possible video channels that the spectator can watch onscreen. The spectator selects the one he or she desires by pressing the appropriate selection keys and confirming the choice by pressing the “enter” key. At this point, the software in the handheld electronic device 16 will instruct the video decoder 714 to start decoding the appropriate channel. The decoded video information will be directed to the screen 802 and it will be displayed to the spectator. At the same time the audio output is played by the speaker/headphones 724.
At any time the spectator can invoke the graphical interface to either stop the video watching or switch to a different video channel.
Data overlay—the spectator can choose to see data content that is overlaid on the screen 802 of the handheld electronic device 16. In a first example, the data content includes information relating to the live sporting event, such as for example scoring and participant ranking information, among others. In the case of a football game, the data content could include the current score, the players that scored, time remaining to play and penalties, among others. In another example, the real-time data content can also convey physiological information associated with anyone of the participants. Again in the context of a football game, the physiological information can include the heart rate of a player or his body temperature, among others. The real time data content is usually available from the authority sanctioning the live sporting event. In the case of the physiological information, a requirement would be to provide one or more of the participants with the necessary sensors that measure the heart rate, body temperature, etc and convey the collected information to the head end station 80 (via the data network 14) such that it can be included in the wireless RF transmission. It is not deemed necessary to describe in detail how the physiological information is collected and delivered to the head end station 80, since this would be known to a person skilled in the art.
When the data is not video channel specific, it can be organized as a “ticker” type band that appears at any appropriate location on the screen and continually cycles information that is updated in real-time. With this example, the same information is seen on each video channel.

### 3. Audio Stream Reception and Related Functions.

The following examples focus on the delivery of the independent audio streams since the handling of the audio streams associated with the respective video streams was described in the earlier section.

As indicated earlier, the independent audio streams convey radio conversations associated with the football game, audio commentaries about the football game or advertisement information, among others. At the handheld electronic device 16 the spectator can manually select anyone of the audio streams and direct them to the output 724 which drives a sound reproducing handheld electronic device such as a loudspeaker or headphones.

### 4. Playing Ancillary Content and Related Functions

In addition to conveying principal video channel content to the spectator, the handheld electronic device 16 is also designed to convey ancillary content. Examples of ancillary content include advertisement content, venue or event related contextual content, on-line shopping options and news, among many others. They can be in the form of video content, audio content or a combination of video and audio content.
Advertisement content—the advertisement content can be delivered in a wide variety of ways to the spectator. Some examples are discussed below:
   The broadcast that is received by the spectator can be provided with an advertisement video channel that can be selected by the spectator in the same manner as he/she selects a principal video channel. For clarity, by principal video channel is meant a video channel that conveys real time video information associated with the live sporting event. Of course there may be more than one advertisement video channel. The channels can be organized in terms of language; for instance, one advertisement video channel in English, one in Spanish and one in French. Alternatively, the channels can be organized in terms of product types or services being promoted.
   The advertisement content is embedded in the video content delivered over a principal video channel. The advertisement content can be inserted at the editing stage on the content production station 54, (see the block diagram in FIG. 3). In this fashion, every spectator receives the same advertisement. The advertisement can be in the form of advertisement clips, such as short movies, banners or graphical elements overlaid on the image or “ticker” type areas running on the screen. It should be appreciated that other ways can also exist for presenting the advertisement video content on the principal video channels without departing from the spirit of the invention.
   The advertisement content can also be embedded in the video content delivered over the principal video channel with the insertion occurring at the handheld electronic device 16, rather than at the content production console. Specifically, the advertisement video content is broadcasted over a dedicated channel and instructions are sent to the handheld electronic device 16 that will control when advertisement content from the advertisement channel is injected in a principal video channel. Such instructions will determine when advisement content will start to be played over the principal video channel and the duration of such play. The instructions are interpreted by the software managing the operation of the handheld electronic device 16 to control when to start injecting the advertisement content and when to stop.
Venue or event related contextual information—Venue related contextual information is information that is associated to the venue where the event is held. In the case of a football game, the venue related contextual information may include:
   Map of the venue;
   Information on key locations such as washrooms, vending stands, medical facilities and emergency exits, among others;
   History of the venue;
   Schedule of future events to be held at the venue;
   Costs schedule for services or products that a spectator may acquire at the venue;
   Local teams playing at this venue (football or other sports).

In a non-limiting embodiment, the handheld electronic device 16 can have GPS receiving capabilities. In such an embodiment, the handheld electronic device 16 is equipped with a GPS device, such that the handheld electronic device 16 can obtain GPS coordinates associated with its location. This assumes the GPS device has an unobstructed view of the sky to pick up satellite signals. More specifically, these GPS coordinates can be displayed to a spectator on the display 802 of the handheld electronic device 16, in relation to a map of the venue, specifically showing to the spectator its location relative to the map. As such, the spectator will know where he/she is in relation to the layout of the venue.

These GPS coordinates can enable the spectator to locate him/herself in relation to specific facilities at the live sporting event. For example, the transmitter 18 can transmit to the handheld electronic devices 16 in the wireless RF broadcast cartographic data. For example, the cartographic data provides a map of the venue and shows the location on some key facilities such as washrooms, food vendors, medical/emergency facilities, exits, etc. . . . The handheld electronic device 16 then stores this geographic data in its memory 702, such that it can be easily accessed by the processor 700. As such, when GPS coordinates are produced a portion of the map or the map in its entirety is shown on the display 802, depending on the zoom level, identifying the location of the spectator. The locations of these facilities can then also be displayed on the map of the venue along with the GPS coordinates of the spectator. In this manner, the spectator would be able to locate him/herself in relation to these facilities.

The facilities can be displayed on the map of the venue in the form of symbols, or text. Preferably, the symbols or text would be indicative of the service/facility that is located at that area on the map. For example, the medical/emergency facilities may be depicted on the map via a red cross, the washroom facilities may be depicted by a W/C sign, or the traditional man and woman signs [symbol] the food facilities may be depicted by a knife and fork symbol [symbol] etc. . . . In addition, the location of the handheld electronic device 16 can also be depicted on the map via an icon, such as a star, for example, such that the spectator knows where he/she is in relation to the other facilities depicted on the map. In an alternative embodiment, the position of the handheld electronic device 16 may just be depicted via a flashing dot.

In order to avoid the map being overcrowded with symbols for each of the different facilities available, the spectator could select which facilities to display on the map by a specific type of facility from a menu. For example, if a spectator needs to find the washrooms, they may access the map of the venue and have the icons associated with the washrooms appear on the map, as well as an icon associated with the position of the spectator. In that manner, the spectator will have a clear indication as to where the closest washroom is located.

In yet another possibility, the handheld electronic device 16 may be equipped with software that enables the handheld electronic device 16 to provide the spectator with directions as to how to get to a certain location. For example, based on the GPS coordinates of the handheld electronic device 16, and the GPS coordinates of a selected location stored in the GPS coordinates database, the processor 700 can use the direction software to determine the best route to get from where the spectator currently is, to the desired location. These directions can then be displayed to the spectator on the handheld electronic device 16 screen 802. The manner in which the spectator requests directions can be done in a variety of ways without departing from the spirit of the invention. In one example, the spectator may simply access a directions menu, and select from a list of options such as “directions to the washrooms”, “directions to the nearest exit”, “directions to the hot dog stand” etc. Alternatively, the spectator could highlight a specific facility icon depicted on the screen via up/down buttons on the keypad 800, and then hit an “enter” button in order to select that icon. The directions software would then provide directions to the facility associated with the selected icon. The directions provided to the user can be in the form of a text listing the route to follow or in the form of arrows showing a path to follow on the map of the venue.

The handheld electronic device 16 may also enable the spectator to store user-defined GPS coordinates into its memory 702. This may be desirable in the case where the spectator wants to remember specific locations at the venue. For example, in the case where a spectator parks his/her car in the stadium's parking lot, upon exiting the car, the spectator may choose to store the GPS coordinates associated with the location of the car in the memory 702 of the handheld electronic device 16. This could be done by invoking the GPS feature on the user interface, and then selecting a “store coordinates” option from a menu item with the appropriate selection keys. The coordinates could then be confirmed and stored by pressing an “enter” key. Those coordinates can then be associated with any suitable icon displayed on the map, thus allowing the spectator to quickly and conveniently find the location of the car. An advantage of this feature could be that at the end of the live sporting event, when the spectator wants to find his/her car, they would then be able to use the directions feature, as described above, to get directions from their current location, back to the GPS coordinates associated with their car.

Event related contextual information is information relating to the event held at the venue. In the example of a football game event, the following is considered to be event related contextual information:
The teams that will be playing;
Profile of individual players;
Current standings in the championship of the teams or individual players;
Information about individual players, such as statistics, pictures of the player, list of awards, records, etc;
Information about the regulations on how the football game is played.

The venue or event related contextual information could be delivered to the spectator over a dedicated channel that the spectator can select for viewing at his/her leisure. The channel selection is effected as described earlier. Alternatively, the venue or event related contextual information could be embedded in the video content of a principal video channel.

The ancillary content provided to the spectator over the wireless RF transmission can also include:

News—Relates to different types of news service, such as “breaking news”, weather information and economic information, among others. The news information can be delivered to the spectator in the same fashion as in the case of the venue or event related contextual information.
Trivia/Surveys/Games—Provides the spectator with trivia questions, or surveys or games in order to keep the spectator occupied during down-time at the event.
Meteorological/Environmental information—This information would provide the spectator with current weather information and a forecast for future weather conditions. This may be particularly useful at outdoor events where spectators want advance notice if it is going to start raining or snowing. The environmental information may provide the spectator with environmental conditions associated with the live sporting event.
Shopping information—Provides the spectator with information allowing the spectator to purchase products or services related to the live sporting event, such as T-shirts, caps, etc.

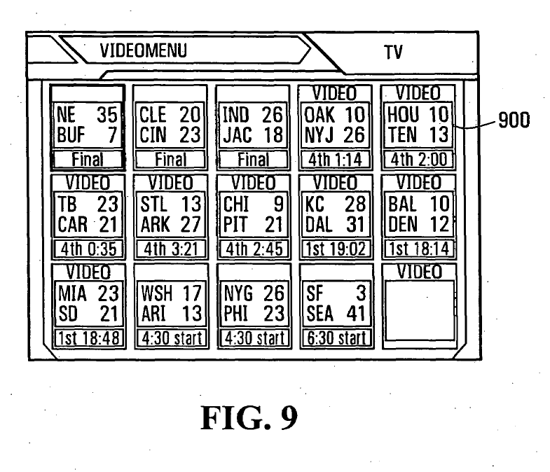

FIGS. 9 to 14 are more detailed examples of the operation of the handheld electronic device 16, showing in particular menu possibilities and different types of information that can be delivered. It should be expressly noted that the above are merely examples that should not be used to limit the scope of the present invention.

FIG. 9 shows an example of the user interface in the form of a GUI that provides the spectator with a menu allowing the spectator to choose video channels to watch on the handheld electronic device 16. The menu provides a list of video streaming options from which the spectator can make a selection. The video channels appear as individual graphical option items, each item being associated with a respective video channel (having a video stream part and audio stream part). Each graphical option item can be individually selected by the spectator. A navigation system allows the spectator to select anyone of the graphical option items. The navigation system can be designed to use arrows and when the channel selection has been made, the spectator presses the “enter” key to access the video content for the selected channel. Each graphical option item is in the form of a box 900. The box 900 provides identifying information describing a characteristic of the football game corresponding to the box 900. The identifying information shows:
The teams that are playing (for example by listing the team identifiers or showing team logos);
The current score;
Play time such as the time from the start of the game or remaining to play;
The current quarter of the game.

Note that some of the boxes 900 are identified with the “video” label which shows that an active video channel is associated with that box 900. This means that the spectator can see the live action for that particular game by selecting this channel. Some of the boxes 900 are blanked and do not show “video”. Those boxes 900 are associated with games that are now over and there is no available live video feed. Nevertheless, the box 900 shows the final score for that game.

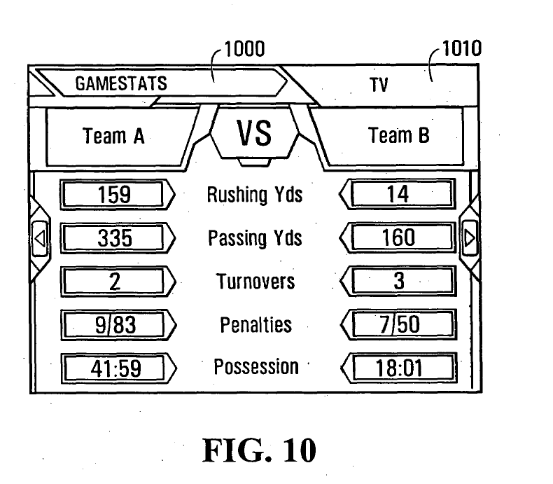

FIG. 10 illustrates another menu item that allows the spectator to obtain information on game statistics. This menu item can be accessed by selecting (via arrows activation followed by “enter” key) the “Gamestats” tab 1000 on the top of the display screen. The spectator can toggle between the video channel menu (FIG. 9) and the Gamestats menu by selecting the appropriate tab (Gamestats tab 1000 and TV tab 1010). On the Gamestats tab 1000 the spectator can see different statistics associated with the teams involved in a particular game for which a live video channel is available or the games that are over. Those statistics include the number of rushing yards, passing yards, turnovers, penalties and possession. The spectator can watch the video channel for a certain game and if he/she desired statistical information about the teams and that particular game the spectator can access the page at FIG. 10.

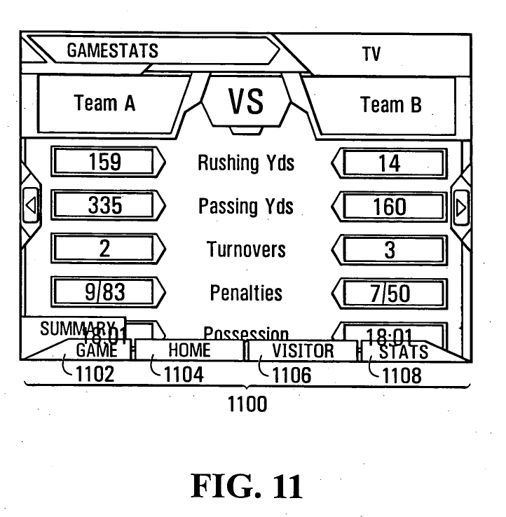

FIG. 11 shows the soft keys 1100 that are assigned to keys 810 (F1, F2, F3 or F4). These keys allow the spectator to obtain additional information about the games, teams and individual players. Four keys are defined, namely the Game key 1102 that is associated with F1, the Home team key 1104 that is associated with F2, the Visitor team key 1106 that is associated with key F3 and the Stats key 1108 that is associated with key F4.

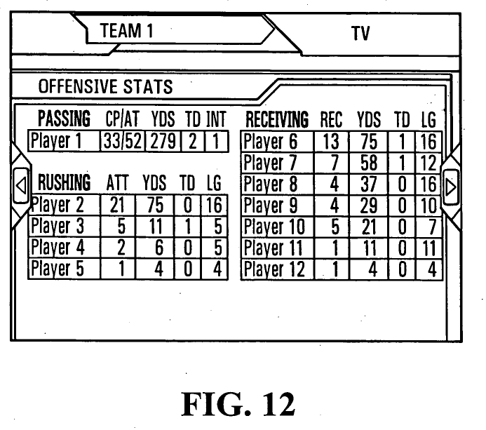

FIG. 12 shows information about a particular team, for example the home team. In this example, the page displays statistical offensive information providing for different players, data on passing, rushing and receiving.

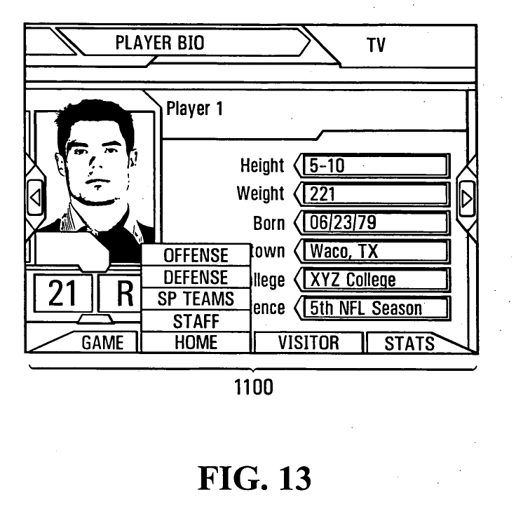

FIG. 13 shows that the soft keys 1100 have sub-menus allowing the spectator to access detailed information on to the general category defined by each soft key. For example the soft key 1104 (Home team) contains four menu items, namely Offence, Defense, SP Teams and Staff (for example a selection of the “Offence” menu item will lead to the page shown in FIG. 12). FIG. 13 also shows the type of information available when the bio of a given player is selected. The information includes a picture of the player, his height, his weight, date of birth, hometown, college and experience (number of seasons during which he/she has played).

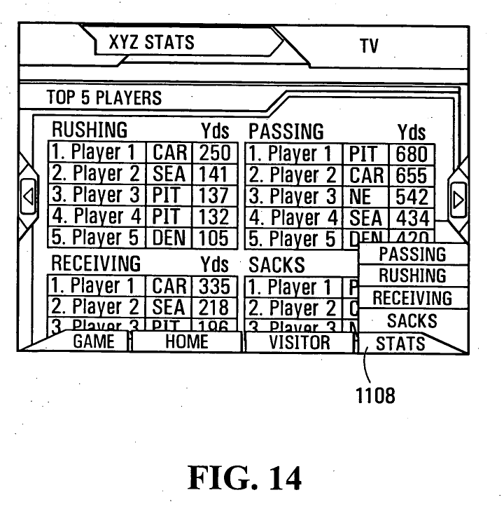

FIG. 14 illustrates that the Stats soft key 1108 leads to sub-menu having 5 items, namely Top 5 players, Passing, Rushing, Receiving and Sacks. The selection of the Top 5 players leads to the page shown in the background. This page provides information on the top 5 players in the rushing, receiving, passing and sacks categories.

Although various embodiments have been illustrated, this was for the purpose of describing, but not limiting, the invention. Various modifications will become apparent to those skilled in the art and are within the scope of this invention, which is defined more particularly by the attached claims.

1) Method for enhancing the experience of a spectator attending a venue hosting a live sporting event, comprising:
a) providing a signal containing a plurality of video streams, wherein:
i) at least one of the video streams is derived from a camera filming the live sporting event attended by the spectator, the live sporting event being a first live sporting event and the venue being a first venue;
ii) at least one of the video streams being derived from a camera filming a second live sporting event that is hosted at a second venue remote from the first venue, wherein the first and the second live sporting events are concurrent at least in part;
b) using the signal to generate a wireless RF transmission locally of the first venue to allow the spectator to receive the wireless RF transmission with a handheld electronic device having a user interface, the user interface allowing the spectator to select a video stream among the plurality of video streams for display on the handheld electronic device.

2) A method as defined in claim 1, wherein the sporting event is selected in the group consisting of a football game, baseball game, basketball game, hockey game, tennis game, horse race, polo game, golf game, soccer game, motor sports event and an Olympic games event

3) A method as defined in claim 1, wherein the wireless RF transmission is a 2.5 GHz transmission.

4) A method as defined in claim 1, including amplifying the signal and modulating the signal to produce the wireless RF transmission.

5) A method as defined in claim 1, wherein the wireless RF transmission is a broadcast.

6) A method as defined in claim 5, wherein the wireless RF transmission conveying authentication data to prevent unauthorized access to one or more of the video streams in the wireless RF transmission.

7) A method as defined in claim 1, wherein the wireless RF transmission conveying data for setting a user interface of the handheld electronic device.

8) A method as defined in claim 7, wherein the user interface has at least one menu, the data setting the menu.

9) A method as defined in claim 8, wherein the user interface includes a GUI.

10) A method as defined in claim 1, wherein the wireless RF transmission conveying contextual information about the first venue.

11) A method as defined in claim 10, wherein the contextual information includes a map of the first venue.

12) A method as defined in claim 1, wherein the wireless RF transmission conveying advertisement content for display on the handheld electronic device.

13) A method as defined in claim 1, wherein the wireless RF transmission conveying real time data content in connection with the first live sporting event for visual display on the handheld electronic device.

14) A method as defined in claim 11, wherein the real time data content conveys physiological information on a participant in the first live sporting event.

15) A method as defined in claim 12, wherein the physiological information is selected in the group consisting of heart rate and body temperature.

16) A method as defined in claim 13, wherein the first live sporting event is a football game, the real time data content conveying information selected in the group consisting of present score, time remaining to play, penalties, number of time outs left, current down, number of downs left and yardage to go.

17) A method as defined in claim 11, wherein the wireless RF transmission conveying real time data content in connection with the second live sporting event for visual display on the handheld device.

18) A method as defined in claim 15, wherein the real time data content in connection with the second live sporting event conveys physiological information on a participant in the second live sporting event.

19) A method as defined in claim 16, wherein the physiological information is selected in the group consisting of heart rate and body temperature.

20) A method as defined in claim 17, wherein the second live sporting event is a football game, the real time data content in connection with the second live sporting event conveying information selected in the group consisting of present score, time remaining to play, penalties, number of time outs left, current down, number of downs left and yardage to go.

21) Method for enhancing the experience of a first spectator attending a first venue hosting a first live sporting event and of a second spectator attending a second venue hosting a second live sporting event, wherein the first and the second venues are remote from one another and the first and second live sporting events are concurrent at least in part, said method comprising:
a) providing a first signal containing a plurality of video streams, wherein:
i) at least one of the video streams is derived from a camera filming the first live sporting event;
ii) at least one of the video streams is derived from a camera filming the second live sporting event;
b) using the first signal to generate a first wireless RF transmission locally of the first venue to allow the first spectator to receive the first wireless RF transmission with a first handheld electronic device having a user interface, allowing the first spectator to select a video stream among the plurality of video streams for display on the first handheld electronic device;
c) providing a second signal containing a plurality of video streams, wherein:
i) at least one of the video streams is derived from the camera filming the first live sporting event;
ii) at least one of the video streams is derived from the camera filming the second live sporting event;
d) using the second signal to generate a second wireless RF transmission locally of the second venue to allow the second spectator to receive the second wireless RF transmission with a second handheld electronic device having a user interface, the user interface of the second handheld electronic device allowing the second spectator to select a video stream among the plurality of video streams in the second wireless RF transmission for display on the second handheld electronic device.

22) A method as defined in claim 21, wherein the first live sporting event is a football game and the second live sporting event is a football game.

23) A method as defined in claim 21, wherein the first live sporting event is a baseball game and the second live sporting event is a baseball game.

24) A method as defined in claim 21, wherein the first live sporting event is a basketball game and the second live sporting event is a basketball game.

25) A method as defined in claim 21, wherein the first live sporting event is a football game and the second live sporting event is other than a football game.

26) A method as defined in claim 21, wherein the first and the second live sporting events are different sporting events.

27) A method as defined in claim 21, wherein the first and second wireless RF transmissions are 2.5 GHz transmissions.

28) A method as defined in claim 21, wherein the first wireless RF transmission conveying authentication data to prevent unauthorized access to one or more of the video streams in the first wireless RF transmission.

29) A method as defined in claim 28, wherein the second wireless RF transmission conveying authentication data to prevent unauthorized access to one or more of the video streams in the second wireless RF broadcast.

30) A method as defined in claim 29, wherein the authentication data in the first wireless RF transmission is different from the authentication data in the second wireless transmission.

31) A method as defined in claim 21, wherein the first wireless RF transmission conveying first data for setting a user interface of the first handheld electronic device.

32) A method as defined in claim 31, wherein the user interface has at least one menu, the first data setting the menu.

33) A method as defined in claim 32, wherein the user interface includes a GUI.

34) A method as defined in claim 31, wherein the second wireless RF transmission conveying second data for setting a user interface of the second handheld electronic device.

35) A method as defined in claim 34, wherein the user interface of the second handheld electronic device has at least one menu, the second data setting the menu.

36) A method as defined in claim 35, wherein the user interface of the second handheld electronic device includes a GUI.

37) A method as defined in claim 34, wherein the first data and the second data are such as to provide different user interfaces on the first handheld electronic device and on the second handheld electronic device.

38) A method as defined in claim 37, wherein the first data provides the user interface of the first handheld electronic device with a first menu, the second data provides the user interface of the second handheld electronic device with a second menu, the first menu being different than the second menu.

39) A method as defined in claim 38, wherein the first menu and the second menu provide different option lists.

40) A method as defined in claim 38, wherein the first menu and the second menu having different graphical backgrounds.

41) A method as defined in claim 21, wherein the first wireless RF transmission conveying contextual information about the first venue.

42) A method as defined in claim 41, wherein the second wireless RF transmission conveying contextual information about the second venue.

43) A method as defined in claim 42, wherein the first wireless RF transmission conveys contextual information about the first venue that is not conveyed in the second wireless RF transmission.

44) A method as defined in claim 42, wherein the second wireless RF transmission conveys contextual information about the second venue that is not conveyed in the first wireless RF transmission.

45) A method as defined in claim 39, wherein the contextual information in the first wireless RF transmission includes a map of the first venue.

46) A method as defined in claim 45, wherein the contextual information in the second wireless RF transmission includes a map of the second venue.

47) A method as defined in claim 21, wherein the first wireless RF transmission conveying advertisement content for display on the first handheld electronic device.

48) A method as defined in claim 21, wherein the second wireless RF transmission conveying advertisement content for display on the second handheld electronic device.

49) A method as defined in claim 21, wherein the first wireless RF transmission conveying real time data content in connection with the first live sporting event for visual display on the first handheld electronic device.

50) A method as defined in claim 49, wherein the real time data content conveys physiological information on a participant in the first live sporting event.

51) A method as defined in claim 50, wherein the physiological information is selected in the group consisting of heart rate and body temperature.

52) A method as defined in claim 49, wherein the first live sporting event is a football game, the real time data content conveying information selected in the group consisting of present score, time remaining to play, penalties, number of time outs left, current down, number of downs left and yardage to go.

53) A method as defined in claim 49, wherein the first wireless RF transmission conveying real time data content in connection with the second live sporting event for visual display on the first handheld device.

54) A method as defined in claim 53, wherein the real time data content in connection with the second live sporting event conveys physiological information on a participant in the second live sporting event.

55) A method as defined in claim 54, wherein the physiological information is selected in the group consisting of heart rate and body temperature.

56) A method as defined in claim 53, wherein the second live sporting event is a football game, the real time data content in connection with the second live sporting event conveying information selected in the group consisting of present score, time remaining to play, penalties, number of time outs left, current down, number of downs left and yardage to go.

57) A method as defined in claim 21, wherein the second wireless RF transmission conveying real time data content in connection with the first live sporting event for visual display on the second handheld electronic device.

58) A method as defined in claim 57, wherein the real time data content conveys physiological information on a participant in the first live sporting event.

59) A method as defined in claim 58, wherein the physiological information is selected in the group consisting of heart rate and body temperature.

60) A method as defined in claim 57, wherein the first live sporting event is a football game, the real time data content conveying information selected in the group consisting of present score, time remaining to play, penalties, number of time outs left, current down, number of downs left and yardage to go.

61) A method as defined in claim 57, wherein the second wireless RF transmission conveying real time data content in connection with the second live sporting event for visual display on the second handheld device.

62) A method as defined in claim 61, wherein the real time data content in connection with the second live sporting event conveys physiological information on a participant in the second live sporting event.

63) A method as defined in claim 62, wherein the physiological information is selected in the group consisting of heart rate and body temperature.

64) A method as defined in claim 61, wherein the second live sporting event is a football game, the real time data content in connection with the second live sporting event conveying information selected in the group consisting of present score, time remaining to play, penalties, number of time outs left, current down, number of downs left and yardage to go.

65) A data structure embedded in a wireless RF transmission, the wireless RF transmission being intended for reception by a plurality of handheld electronic devices of spectators at a venue hosting a live sporting event, said data structure conveying:
a) at least one video stream derived from a camera filming the live sporting event, the live sporting event being a first live sporting event and the venue being a first venue;
b) at least one of the video streams derived from a camera filming a second live sporting event that is hosted at a second venue remote from the first venue, wherein the first and the second live sporting events are concurrent at least in part, wherein a spectator at the first venue can receive the wireless RF transmission with a respective handheld electronic device having a user interface, allowing the spectator to select a video stream among the plurality of video streams for display on the handheld electronic device;
c) authentication data to prevent an unauthorized handheld electronic device at the first venue[SPG1] from accessing one or more of the video streams in the wireless RF transmission.

66) A data structure as defined in claim 65, wherein the data structure conveys data for setting the user interface of the handheld electronic device of the spectator.

67) A data structure as defined in claim 66, wherein the user interface has at least one menu, the data setting the menu.

68) A data structure as defined in claim 65, wherein the data structure conveys contextual information about the first venue.

69) A data structure as defined in claim 68, wherein the contextual information includes a map of the first venue.

70) A data structure as defined in claim 65, wherein the first live sporting event and the second live sporting event are football games.

71) A data structure embedded in a wireless RF transmission, the wireless RF transmission being intended for reception by a plurality of handheld electronic devices of spectators at a venue hosting a live sporting event, said data structure conveying:
a) at least one video stream derived from a camera filming the live sporting event, the live sporting event being a first live sporting event and the venue being a first venue;
b) at least one of the video streams derived from a camera filming a second live sporting event that is hosted at a second venue remote from the first venue, wherein the first and the second live sporting events are concurrent at least in part, wherein a spectator at the first venue can receive the wireless RF transmission with a respective handheld electronic device having a user interface, allowing the spectator to select a video stream among the plurality of video streams for display on the handheld electronic device;
c) data for setting the user interface of the handheld electronic device of the spectator.

72) A data structure as defined in claim 71, wherein the user interface has at least one menu, the data setting the menu.

73) A data structure as defined in claim 72, wherein the menu has a list of selectable options, the data setting the options.

74) A data structure as defined in claim 71, wherein the data structure conveys contextual information about the first venue.

75) A data structure as defined in claim 74, wherein the contextual information includes a map of the first venue.

76) A data structure as defined in claim 71, wherein the first live sporting event and the second live sporting event are football games.

77) A data structure as defined in claim 71, wherein the data structure conveys authentication data to prevent an unauthorized handheld electronic device at the first venue from accessing one or more of the video streams in the wireless RF transmission.

78) A method for video content production, comprising:
a) receiving at a production site a first signal conveying a video stream derived from a camera filming a live sporting event, the live sporting event being a first live sporting event and being hosted at a first venue;
b) receiving at the production site a second signal conveying a video stream derived from a camera filming a second live sporting event hosted at a second venue that is remote from the first venue;
c) transmitting to the first venue a first data flow conveying a video stream of the first live sporting event and a video stream of the second live sporting event;
d) transmitting to the second venue a second data flow conveying a video stream of the first live sporting event and a video stream of the second live sporting event.

79) A method as defined in claim 78, wherein the first live sporting event and the second live sporting events are concurrent at least in part.

80) A method as defined in claim 79, wherein the first venue is located in a first city and the second venue is located in a second city remote from the first city.

81) A method as defined in claim 80, wherein the first live sporting event and the second live sporting event are football games.

82) A method as defined in claim 80, wherein the first live sporting event and the second live sporting events are baseball games.

83) A method as defined in claim 80, wherein the first live sporting event and the second live sporting event are basketball games.

84) A method as defined in claim 81, including placing in the first data flow authentication data to prevent unauthorized access to one or more of the video streams in the first data flow.

85) A method as defined in claim 84, including placing in the second data flow authentication data to prevent unauthorized access to one or more of the video streams in the second data flow.

86) A method as defined in claim 85, wherein the authentication data in the first data flow is different from the authentication data in the second data flow.

87) A method as defined in claim 81, including placing in the first data flow first data for setting a user interface of a first handheld electronic device intended for displaying to a spectator a selected one of the video streams in the first data flow.

88) A method as defined in claim 87, including placing in the second data flow second data for setting a user interface of a second handheld electronic device intended for displaying to a spectator a selected one of the video streams in the second data flow.

89) A method as defined in claim 88, wherein the first data and the second data are such that the user interface of the first handheld electronic device and the user interface of the second handheld electronic device are different from one another.

90) A method as defined in claim 89, wherein the user interface of the first handheld electronic device includes a menu of options.

91) A method as defined in claim 90, wherein the user interface of the second handheld electronic device includes a menu of options, the menu of options of the user interface of the first handheld electronic device is different from the menu of options of the user interface of the handheld electronic second device.

92) A method as defined in claim 91, wherein the first menu and the second menu provide different option lists.

93) A method as defined in claim 92, wherein the first menu and the second menu having different graphical backgrounds.

94) A method as defined in claim 92, wherein the user interface of the first device is a GUI.

95) A method as defined in claim 94, wherein the user interface of the second device is a GUI.

96) A method as defined in claim 81, including placing in the first data flow contextual information about the first venue.

97) A method as defined in claim 96, including placing in the second data flow contextual information about the second venue.

98) A method as defined in claim 96, wherein the contextual information about the first venue includes a map of the first venue.

99) A method as defined in claim 98, wherein the contextual information about the second venue includes a map of the second venue.

100) A method as defined in claim 97, including placing in the first data flow contextual information about the first venue that is not conveyed in the second data flow.

101) A method as defined in claim 97, including placing in the second data flow contextual information about the second venue that is not conveyed in the first data flow.

102) A video content production studio, comprising a mixing unit that has:
a) an input for receiving a first signal conveying a video stream derived from a camera filming a live sporting event, the live sporting event being a first event and being hosted at a first venue and also for receiving a second signal conveying a video stream derived from a camera filming a second live sporting event hosted at a second venue that is remote from the first venue
b) a mixing unit for processing the first and the second signals and generating:
i) a first data flow conveying a video stream of the first live sporting event and a video stream of the second live sporting event;
ii) a second data flow conveying a video stream of the first live sporting event and a video stream of the second live sporting event;
c) an output for transmitting the first data flow to the first venue and the second data flow to the second venue.

103) A production studio as defined in claim 102, wherein the first live sporting event and the second live sporting event are concurrent at least in part.

104) A production studio as defined in claim 103, wherein the first venue is a first city and the second venue is a second city remote from the first city.

105) A production studio as defined in claim 104, wherein the first live sporting event and the second live sporting event are football games.

106) A production studio as defined in claim 104, wherein the first live sporting event and the second live sporting events are baseball games.

107) A production studio as defined in claim 104, wherein the first live sporting event and the second live sporting event are basketball games.

108) A production studio as defined in claim 105, including placing in the first data flow authentication data to prevent unauthorized access to one or more of the video streams in the first data flow.

109) A production studio as defined in claim 108, including placing in the second data flow authentication data to prevent unauthorized access to one or more of the video streams in the second data flow.

110) A production studio as defined in claim 109, wherein the authentication data in the first data flow is different from the authentication data in the second data flow.

111) A production studio as defined in claim 105, including placing in the first data flow first data for setting a user interface of a first handheld electronic device intended for displaying to a spectator a selected one of the video streams in the first data flow.

112) A production studio as defined in claim 111, including placing in the second data flow second data for setting a user interface of a second handheld electronic device intended for displaying to a spectator a selected one of the video streams in the second data flow.

113) A production studio as defined in claim 112, wherein the first data and the second data are such that the user interface of the first handheld electronic device and the user interface of the second handheld electronic device are different from one another.

114) A production studio as defined in claim 113, wherein the user interface of the first handheld electronic device includes a menu of options.

115) A production studio as defined in claim 85, wherein the user interface of the second handheld electronic device includes a menu of options, the menu of options of the user interface of the first handheld electronic device is different from the menu of options of the user interface of the second handheld electronic device.

116) A production studio as defined in claim 115, wherein the user interface of the first handheld electronic device is a GUI.

117) A production studio as defined in claim 116, wherein the user interface of the second handheld electronic device is a GUI.

118) A production studio as defined in claim 105, including placing in the first data flow contextual information about the first venue.

119) A production studio as defined in claim 118, including placing in the second data flow contextual information about the second venue.

120) A production studio as defined in claim 119, wherein the contextual information about the first venue includes a map of the first venue.

121) A production studio as defined in claim 120, wherein the contextual information about the second venue includes a map of the second venue.

122) A production studio, as defined in claim 90, wherein the contextual information in the first data flow is different from the contextual information in the second data flow.

123) A production studio as defined in claim 119, wherein the contextual information in the first data flow conveys information about the first venue that is not conveyed in the contextual information in the second data flow.

124) A production studio as defined in claim 123, wherein the contextual information in the second data flow conveys information about the second venue that is not conveyed in the contextual information in the first data flow.

125) A production studio as defined in claim 102, wherein said input receives the first and second signals from a data transport network.

126) A production studio as defined in claim 125, wherein said output connects to said data transport network.

127) A production studio as defined in claim 102, including an authentication database.

128) A production studio as defined in claim 102, including an ancillary content database.

129) A method for graphically presenting to a spectator attending a first live sporting event a list of video streaming options from which the spectator can select a desired video stream for viewing on a screen of a handheld electronic device, wherein at least one of the video streaming options conveys video content derived from a camera filming a second live sporting event that is concurrent at least in part with the first live sporting event, said method comprising:
a) displaying on the screen of the handheld electronic device a series of graphical option items associated with respective ones of the video streams, said option items being individually selectable by the spectator to effect a choice of a video stream to view on the screen;
b) displaying on the screen identifying information in connection with each option item, the identifying information describing a characteristic of the live sporting event from which the video stream associated with the option item is derived.

130) A method as defined in claim 129, wherein the video streams associated with the option items are delivered wirelessly to the handheld electronic device.

131) A method as defined in claim 130, wherein the video streams associated with the option items are delivered to the handheld electronic device via a wireless RF transmission.

132) A method as defined in claim 131, wherein the wireless RF transmission is a broadcast.

133) A method as defined in claim 132, wherein the graphical option items and the identifying information are part of a GUI of the handheld electronic device.

134) A method as defined in claim 133, wherein the wireless RF transmission conveys data for setting the GUI.

135) A method as defined in claim 134, wherein the data defines the graphical option items available for selection by the spectator.

136) A method as defined in claim 134, wherein the data conveys the identifying information.

137) A method as defined in claim 134, wherein the data determines one or more characteristics of the graphical option items available for selection by the spectator.

138) A method as defined in claim 130, wherein the first live sporting event is a football game.

139) A method as defined in claim 138, wherein the second live sporting event is a football game.

140) A method as defined in claim 139, wherein at least one of the video streams is derived from a camera filming the first live sporting event.

141) A method as defined in claim 140, wherein the identifying information on the graphical option item associated with the video stream derived from the camera filming the second live sporting event conveys the identity of the football teams playing the football game.

142) A method as defined in claim 140, wherein the identifying information on the graphical option item associated with the video stream derived from the camera filming the second live sporting event conveys the current score of the football game.

143) A method as defined in claim 140, wherein the identifying information on the graphical option item associated with the video stream derived from the camera filming the second live sporting event conveys the current quarter of the football game.

144) A method as defined in claim 140, wherein the identifying information on the graphical option item associated with the video stream derived from the camera filming the second live sporting event conveys play time information.

145) A handheld electronic device for use by a spectator at a venue hosting a live sporting event, wherein the venue is a first venue and the live sporting event is a first live sporting event, said handheld electronic device comprising:
a) a receiver for receiving a wireless RF transmission containing at least two video streams conveying live video sporting event content, one of the video streams being derived from a camera filming the first live sporting event and one of the video streams being derived from a camera filming a second live sporting event held at a second venue that is remote from the first venue;
b) a screen;
c) a user interface for selecting a video stream among said plurality of video streams to be viewed on said screen, said user interface capable of displaying on said screen a series of graphical option items associated with respective ones of the video streams, said option items being individually selectable by the spectator to effect a choice of a video stream to view on the screen.

146) A handheld electronic device as defined in claim 145, wherein said user interface displaying on the screen identifying information in connection with each option item, the identifying information describing a characteristic of the live sporting event from which the video stream associated with the option item is derived.

147) A handheld electronic device as defined in claim 146, wherein the wireless RF transmission is a broadcast.

148) A handheld electronic device as defined in claim 146, wherein the user interface is a GUI.

149) A handheld electronic device as defined in claim 148, wherein the wireless RF transmission conveys data for setting the GUI.

150) A handheld electronic device as defined in claim 149, wherein the data defines the graphical option items available for selection by the spectator.

151) A handheld electronic device as defined in claim 149, wherein the data conveys the identifying information.

152) A handheld electronic device as defined in claim 149, wherein the data determines one or more characteristics of the graphical option items available for selection by the spectator.

153) A handheld electronic device as defined in claim 146, wherein the first live sporting event is a football game.

154) A handheld electronic device as defined in claim 146, wherein the second live sporting event is a football game.

155) A handheld electronic device as defined in claim 146, wherein at least one of the video streams is derived from a camera filming the first live sporting event.

156) A handheld electronic device as defined in claim 154, wherein the identifying information on the graphical option item associated with the video stream derived from the camera filming the second live sporting event conveys the identity of the football teams playing the football game.

157) A handheld electronic device as defined in claim 154, wherein the identifying information on the graphical option item associated with the video stream derived from the camera filming the second live sporting event conveys the current score of the football game.

158) A handheld electronic device as defined in claim 154, wherein the identifying information on the graphical option item associated with the video stream derived from the camera filming the second live sporting event conveys the current quarter of the football game.

159) A handheld electronic device as defined in claim 154, wherein the identifying information on the graphical option item associated with the video stream derived from the camera filming the second live sporting event conveys play time information.
